(19) United States
(12) Patent Application Publication
(10) Pub. No.: US 2008/0198110 A1
(43) Pub. Date: Aug. 21, 2008

(54) LIQUID CRYSTAL DISPLAY DEVICE

(76) Inventor: Tohru SASAKI, Mobara (JP)

Correspondence Address: ANTONELLI, TERRY, STOUT & KRAUS, LLP, 1300 NORTH SEVENTEENTH STREET, SUITE 1800, ARLINGTON, VA, 22209-3873, US

(21) Appl. No.: 12/033,909

(22) Filed: Feb. 20, 2008

(30) Foreign Application Priority Data
Feb. 21, 2007 (JP) 2007-040851

(51) Int. Cl. G06F 3/041

(52) U.S. Cl. 345/87

(57) ABSTRACT

A liquid crystal display device includes a liquid crystal display panel provided with plural sub-pixels, plural video wirings for inputting the video voltage to the sub-pixels, plural main-scanning wirings for inputting the selective scanning voltage to the sub-pixels, plural sub-scanning wirings provided corresponding to the plural the main-scanning wirings, and a retention capacity wiring. The sub-pixel includes a pixel electrode, an opposed electrode, a main transistor and a sub transistor. An opposed voltage generation circuit is provided for supplying the opposed voltage to the opposed electrode. The main transistor has a gate electrode connected to the main-scanning wiring, a first electrode connected to the video wiring, and a second electrode connected to the pixel electrode. The sub transistor has a gate electrode connected to the sub-scanning wiring, a first electrode connected to the retention capacity wiring, and a second electrode connected to the pixel electrode.

### CLAIM OF PRIORITY

The present application claims priority from Japanese Application JP 2007-040851 filed on Feb. 21, 2007, the content of which is hereby incorporated by reference into this application.

### BACKGROUND OF THE INVENTION

1. Field of the Invention

The invention relates to a liquid crystal display device, and more particularly, to a liquid crystal display device which supplies the voltage of the retention capacity wiring or the common electrode by the sub-TFT connected to the sub-scanning wiring to perform the black frame insertion.

2. Description of the Related Art

The hold type display device such as the liquid crystal display device (LCD) has been known to repeatedly display the single black frame after displaying the single image frame and to insert the black frame between the image frames to realize the false impulse display to approximate the Cathode Ray Tube (CRT) for improving the blurred image.

In the case where the blurred image cannot be sufficiently improved, or the flickering is observed, it is well known to increase the frame frequency two or three times higher than usual. In the aforementioned case, the voltage for the black frame insertion is supplied through the video wiring likewise the video voltage for displaying the normal image.

Meanwhile, Japanese Unexamined Patent Application Publication No. 2001-108965 discloses the liquid crystal display device with the pixel structure including the sub thin film transistor and the sub-scanning wiring, which is capable of performing the excellent display in the sharp contrast in spite of the high precision liquid crystal display panel.

With the generally employed black frame insertion technique, when the frame frequency is increased to improve the blurred video image and to prevent flickering, the time for selecting the respective scanning wirings is reduced, and accordingly, the time for which the transistor connected to the scanning wiring is kept ON is reduced. As a result, it is difficult to sufficiently charge the pixel electrode to the desired video voltage, that is, to perform writing. The aforementioned insufficient writing is likely to cause the brightness gradient and the uneven display.

When the output voltage of the drive circuit is entirely increased to compensate the writing insufficiency, the power consumption is also increased. Alternatively, the frame frequency is increased to raise the operation frequency for the entire drive circuit, thus increasing the power consumption.

### SUMMARY OF THE INVENTION

It is an object of the invention to provide a liquid crystal display device capable of performing the black frame insertion without increasing the power consumption.

The manner in which the foregoing another objects of the invention are accomplished will be apparent from the accompanying specification and claims considered together with the drawings.

The representative features of the invention will be briefly described hereinafter.

(A) An active matrix type liquid crystal display device using the thin film transistor is provided with a main-scanning wiring, and the retention capacity wiring and the sub-scanning wiring corresponding to the main-scanning wiring. The main transistor and the sub transistor are provided for each of the sub-pixels.

The gate electrode, the drain electrode (or source electrode), and the source electrode (or drain electrode) of the sub transistor are connected to the sub-scanning wiring, the retention capacity wiring, and the pixel electrode, respectively.

The gate electrode, the drain electrode (or source electrode), and the source electrode (or drain electrode) of the main transistor are connected to the main scanning wiring, the video wiring, and the pixel electrode, respectively.

The retention capacity is formed between the retention capacity wiring and at least one of the source electrode (or drain electrode) of the main transistor and the sub transistor and the pixel electrode. The pixel capacity is formed between the pixel electrode and the opposed electrode (common electrode) via the liquid crystal layer.

The drain electrode (or source electrode) of the sub transistor may be connected to the opposed electrode of the sub pixel adjacent to the side to be scanned subsequent to the subject sub pixel in the screen scanning direction. The drain electrode (or source electrode) of the sub transistor may be connected to the opposed electrode of the sub pixel adjacent to the side scanned prior to the subject sub-pixel in the screen scanning direction.

For the first scanning period, when the main-scanning wiring is in the selective state, the video voltage corresponding to the image signal is supplied from the video wiring to the pixel electrode via the main transistor. When the main-scanning wiring is in the non-selective state, the main transistor is turned OFF where the charge stored in the pixel electrode is retained. For the first scanning period, the sub-scanning wiring is kept in the non-selective state. The voltage corresponding to the image signal is applied to the pixel capacity of each of the sub pixels to operate the liquid crystal layer, thus displaying the image.

For the second scanning period, when the sub-scanning wiring is brought into the selective state while keeping the main-scanning wiring in the non-selective state, the sub transistor becomes ON while keeping the main transistor OFF. The retention capacity voltage is supplied from the retention capacity wiring to the pixel electrode via the sub transistor in ON state. The difference between the retention capacity voltage and the opposed voltage supplied to the opposed electrode is set to the value substantially corresponding to the black frame insertion voltage in the liquid crystal display mode to be used. Thereafter, the electric charge stored in the pixel may be retained by bringing both the main-scanning wiring and the sub-scanning wiring into the non-selective state. In the aforementioned case, the retention capacity voltage is set to be higher by the amount corresponding to the feed through voltage to the pixel electrode voltage resulting from the decrease in the gate electrode voltage of the sub transistor accompanied with switching of the sub-scanning wiring from the selective state to the non-selective state. Preferably the difference between the DC voltage component of the pixel electrode voltage waveform subsequent to switching of both the main-scanning wiring and the sub-scanning wiring into the non-selective states and the DC voltage component of the opposed voltage waveform supplied to the opposed electrode is set to become substantially zero.

The AC drive is performed by repeating the first scanning period and the second scanning period alternately.

In the case where the normally black (hereinafter referred to as NB) mode for the black frame display where no voltage is applied is used as the liquid crystal display mode, the retention capacity voltage is set to be substantially equal to the opposed voltage. At this time, the respective retention capacity wirings may be commonly or independently used. Alternatively, the retention capacity voltage may have the polarity with respect to the opposed voltage changed for each of the second scanning periods alternately such that the absolute value of the difference between the retention capacity voltage and the opposed voltage becomes the value substantially corresponding to the black frame display voltage in the NB display mode. In this case, the respective retention capacity wirings are independently provided, and the retention capacity voltage may be switched in synchronization with the scanning performed by the main-scanning wiring or the sub-scanning wiring.

In the case where the normally white (hereinafter referred to as NW) mode for the white frame display where no voltage is applied is used as the liquid crystal display mode, the retention capacity voltage is set such that the polarity with respect to the opposed voltage is alternately switched for each of the second scanning periods, and the absolute value of the difference between the retention capacity voltage and the opposed voltage becomes the value substantially corresponding to the black frame display voltage of the NW display mode. The respective retention wirings are independently provided, and the retention capacity voltage is switched in synchronization with the scanning performed by the main-scanning wiring and the sub-scanning wiring.

The screen scanning in the second scanning period is started during the period from the start to the end of the screen scanning in the first scanning period. The length of the second scanning period is not necessarily equal to that of the first scanning period. However, the interval between the second scanning periods is required to be equal to the one between the first scanning periods. The screen scanning in the second scanning period may be started at the end of the screen scanning in the first scanning period. Then the screen scan in the first scanning period may be started again at the end of the screen scanning in the second scanning period.

As the main transistor and the sub transistor, the amorphous silicon thin film transistor (TFT) using the amorphous silicon (a-Si) as the semiconductor layer, the polysilicon thin film transistor (TFT) using the polysilicon (for example, low temperature polysilicon) as the semiconductor layer, and the transistor using the generally employed crystal silicon as the semiconductor layer may be employed.

Preferably, each retention capacity voltage is constant both for the first and the second scanning periods. It is preferable to set the opposed voltage such that the DC voltage component of the voltage waveform applied to the pixel capacity becomes substantially zero.

As the liquid crystal display mode, the NB mode, for example, the in-plane switching (IPS) mode, the vertical alignment (VA) mode, the birefringent type twisted nematic mode (TN), the TN mode twisted at 90°, and the NW mode, for example, homogenous aligned electric field birefringent (ECB) mode, the optical compensation bend mode may be employed. In any of the aforementioned modes, the pixel structure such as the transmission type, reflection type, and partially transmission-reflection type, or the light alignment division mode may be employed.

(B) In case of the IPS display mode, in the liquid crystal display mode as the NB display mode, the opposed electrode serves as the retention capacity wiring, and the retention capacity voltage corresponds to the opposed voltage supplied to the opposed electrode. In the second scanning period described in the feature (A), the sub-scanning wiring is brought into the selective state while keeping the main-scanning wiring in the non-selective state, and the sub transistor is kept ON while keeping the main transistor OFF. The opposed voltage is continuously applied to the pixel electrode via the sub transistor in ON state which are kept until the main-scanning wiring in transition to the first scanning period becomes the selective state, and the sub-scanning wiring becomes the non-selective state, respectively. The respective opposed electrodes may be employed commonly or independently.

Alternatively, in case of the IPS display mode, after the sub-scanning wiring is brought into the selective state while keeping the main-scanning wiring in the non-selective state in the second scanning period, both the main-scanning wiring and the sub-scanning wiring are brought into the non-selective states. The opposed voltage is increased in the first scanning period simultaneously with bringing the sub-scanning wiring into the selective state while keeping the main-scanning wiring in the non-selective state. Then the opposed voltage is lowered in synchronization with bringing both the main-scanning wiring and the sub-scanning wiring into the non-selective state. The amount of the decrease in the opposed voltage is determined such that the difference between the pixel electrode voltage and the opposed voltage after both the main-scanning wiring and the sub-scanning wiring become the non-selective state reaches substantially zero in accordance with the magnitude of the feed through voltage to the pixel electrode voltage resulting from the decrease in the gate electrode voltage of the sub transistor and that of the feed through voltage to the pixel electrode voltage resulting from the decrease in the opposed voltage upon switching of the selective state of the sub-scanning wiring to the non-selective state. After the elapse of the second scanning period following the first scanning period for which the main-scanning wiring becomes the selective state and the sub-scanning wiring becomes the non-selective state, the opposed voltage is returned to the value in the first scanning period again. The respective opposed electrodes are provided independently such that the opposed voltage is switched in synchronization with the scanning of the main-scanning wiring and the sub-scanning wiring as described above.

(C) In the IPS display mode, the following structure may be employed. The opposed electrode and the sub-scanning wiring are provided corresponding to the main-scanning wiring. The main transistor and the sub transistor are provided for each of the sub-pixels. The gate electrode, the drain electrode (or the source electrode), and the source electrode (or drain electrode) of the sub transistor are connected to the sub-scanning wiring, the opposed electrode of the sub-pixel adjacent to the side subsequently scanned in the screen scanning direction, and the pixel electrode, respectively.

The gate electrode and the source electrode (or drain electrode) of the main transistor are connected to the main-scanning wiring and the pixel electrode, respectively. The retention capacity is formed between the opposed electrode and at least one of the source electrode (drain electrode) of the main transistor or the sub transistor, or the pixel electrode. The pixel capacity is formed between the pixel electrode and the opposed electrode via at least the liquid crystal layer.

In the second scanning period described in the feature (A), after the sub-scanning wiring is brought into the selective state while keeping the main-scanning wiring in the non-selective state, both the main scanning wiring and the sub-scanning wiring are brought into the non-selective states. The opposed voltage is made lower than the one in the first scanning period in synchronization with bringing the sub-scanning wiring into the selective state while keeping the main-scanning wiring in the non-selective state. The voltage is maintained after bringing the main-scanning wiring and the sub-scanning wiring into the non-selective state.

The opposed voltage supplied to the opposed electrode of the sub-pixel adjacent to the side subsequently scanned in the screen scanning direction is changed in synchronization with bringing the sub-scanning wiring into the selective state while keeping the main-scanning wiring of the sub-pixel in the non-selective state. While the subject sub-pixel is switched to the second scanning period to bring the sub-scanning wiring into the selective state while keeping the main-scanning wiring in the non-selective state, the voltage in the first scanning period is maintained. The force to reduce the opposed voltage supplied to the opposed electrode is set such that the difference between the opposed voltage and the pixel electrode voltage after the main-scanning wiring and the sub-scanning are brought into the non-selective state becomes substantially zero in accordance with the feed through voltage to the pixel electrode voltage resulting from the decrease in the gate electrode voltage of the sub transistor accompanied with switching of the sub-scanning wiring from the selective state to the non-selective state.

After the second scanning period following the first scanning period, the main-scanning wiring and the sub-scanning wiring are brought into the non-selective state and the selective state. The opposed voltage supplied to the opposed electrode is then returned to the value in the first scanning period again. The respective opposed electrodes are provided independently such that the opposed voltage supplied to the opposed electrode may be switched in synchronization with the scanning performed by the main-scanning wiring and the sub-scanning wiring.

Alternatively, with the pixel structure in the IPS display mode, the sub-scanning wiring is brought into the selective state while keeping the main-scanning wiring in the non-selective state in the second scanning period as described in the feature (A). Then the sub transistor is kept ON while keeping the main transistor OFF. The opposed voltage is continuously applied to the pixel electrode from the opposed electrode via the sub transistor kept in ON state. The respective opposed electrodes may be commonly or independently provided.

(D) In the case where the IPS display transmission portion in the NB display mode and the IPS display reflection portion in the NW display mode are respectively provided in the single sub-pixel, the following structure may be formed.

The main-scanning wiring, and the opposed electrodes for the transmission portion and the reflection portion, and the sub-scanning wiring are provided corresponding to the main-scanning wiring. The main transistor and the sub transistor are provided for each of the sub-pixels. The gate electrode, the drain electrode (or source electrode) and the source electrode (or drain electrode) of the sub transistor are connected to the sub-scanning wiring, the video wiring, and the pixel electrode, respectively.

The gate electrode, the drain electrode (or source electrode), and the source electrode (or drain electrode) of the main transistor are connected to the main-scanning wiring, the video wiring, and the pixel electrode, respectively. The retention capacity is formed between at least one of the source electrode (or drain electrode) of the main transistor or the sub transistor and the pixel electrode, and the opposed electrodes for the transmission portion and for the reflection portion.

The pixel capacity for the transmission portion and the pixel capacity for the reflection portion are formed between the pixel electrode and the opposed electrode for the transmission portion, and between the pixel electrode and the opposed electrode for the reflection portion via the liquid crystal layers, respectively.

The opposed electrode for the transmission portion (or the opposed electrode for the reflection portion) is commonly used as the one for the reflection portion (or for the transmission portion) of the sub-pixel adjacent to the side previously scanned in the screen scanning direction. The opposed electrode for the reflection portion (or the opposed electrode for the transmission portion) is commonly used as the one for the transmission portion (or for the reflection portion) of the sub-pixel adjacent to the side subsequently scanned in the screen scanning direction.

Assuming that the time for selecting the main-scanning wiring in the first scanning period is set to tL, the voltage of the opposed electrode for the transmission portion (opposed electrode for the reflection portion) commonly used as the one for the reflection portion of the sub-pixel adjacent to the side previously scanned in the screen scanning direction is switched at least tL before the main-scanning wiring is brought into the selective state. Then the voltage of the opposed electrode for the reflection portion (or the opposed electrode for the transmission portion) commonly used as the one for the transmission portion (or the opposed electrode for the reflection portion) of the sub-pixel adjacent to the side subsequently scanned in the screen scanning direction is switched when bringing the main-scanning wiring into the selective state.

In the case where the main-scanning wiring is in the selective state, the video voltage corresponding to the video signal is supplied to the pixel electrode from the video wiring via the main transistor in ON state. When the main-scanning wiring is in the non-selective state, the main transistor becomes OFF to hold the electric charge stored in the pixel electrode.

The sub-scanning wiring is kept in the non-selective state during the first scanning period. The opposed voltage supplied to the opposed electrode for the transmission portion is different from the opposed voltage supplied to the opposed electrode for the reflection portion. Each transmission portion in the respective sub-pixels receives the differential voltage between the pixel electrode voltage and the opposed voltage supplied to the opposed electrode for the transmission portion to operate the liquid crystal layer thereof. The reflection portion receives the differential voltage between the pixel electrode voltage and the opposed voltage supplied to the opposed electrode for the reflection portion to operate the liquid crystal layer thereof. The transmission display image and the reflection display image are displayed.

In the second scanning period, the sub-scanning wiring is brought into the selective state while keeping the main-scanning wiring in the non-selective state. The sub transistor is kept ON while keeping the main transistor OFF. The opposed voltage supplied to the opposed electrode for the transmission portion is continuously applied to the pixel electrode via the sub transistor in ON state until the transition to the first scanning period for which the main-scanning wiring becomes the selective state and the sub-scanning wiring becomes the non-selective state. The voltage of substantially 0 is applied to the transmission portion, and the differential voltage between the opposed voltage supplied to the opposed electrode for the transmission portion and the opposed voltage supplied to the opposed electrode for the reflection portion is applied to the reflection portion. The difference between the opposed voltage supplied to the opposed electrode for the transmission portion and the opposed voltage supplied to the opposed electrode for the reflection portion is set to the value at least corresponding to the black frame display voltage in the liquid crystal display mode to be employed.

The AC drive is performed by repeating the first and the second scanning periods alternately. The respective opposed electrodes are independently provided so as to switch between the opposed voltage supplied to the opposed electrode for the transmission portion and the opposed voltage supplied to the opposed electrode for the reflection portion in synchronization with the scanning of the main-scanning wiring as described above.

The representative advantages derived from the above-structured invention will be described hereinafter.

The invention provides the liquid crystal display device with excellent video display performance for producing the bright and high quality images without increasing the power consumption.

In the invention, the image is displayed in the first frame time, and the differential voltage between the pixel electrode voltage and the opposed voltage becomes the value substantially corresponding to the black frame display voltage in the display mode to be employed in the second frame time. Then the voltage corresponding to the black frame display is applied to the pixel capacity in the respective sub-pixels to display the black frame.

The first and the second frame times may be alternately repeated to display the image and the black frame alternately. This makes it possible to insert the black frame between the images to improve the video quality.

During the period from the start to the end of the image scanning in the first frame time, the image scanning may be started in the second frame time so as to reduce the cycle time for switching between the image and the black frame. This makes it possible to increase the apparent frame frequency.

Accordingly, the blurred image may be improved, and the flickering may also be prevented. As the selection time tL for the main-scanning wiring in the first frame time does not have to be reduced, the pixel electrode may be sufficiently charged until the desired video voltage while keeping the main transistor (Qa) in ON state. The brightness gradient and the uneven display may be suppressed without increasing the output voltage from the video wiring drive circuit or increasing the power consumption.

As the actual frame frequency does not have to be increased, the operation frequency of the entire drive circuit may be prevented from increasing. This makes it possible to perform the black frame insertion at the increased apparent frame frequency without increasing the power consumption. The length of the second frame time does not have to be made equal to that of the first frame time. The length of the second frame time is made shorter than that of the first frame time to reduce the display time of the black frame insertion shorter than that of the image display. The deterioration in the display brightness may be suppressed. Alternatively, the correlation of the length between the second frame time and the first frame time may be adjusted in accordance with the response characteristic of the liquid crystal layer to be employed, the required video performance, the display brightness and the like.

### BRIEF DESCRIPTION OF THE DRAWINGS

FIG. 1A is a view schematically showing the structure of a liquid crystal display device according to a first embodiment of the invention.

FIG. 1B is an equivalent circuit diagram of an image structure of the liquid crystal display device according to the first embodiment of the invention.

FIG. 1C is a sectional view schematically showing the structure of an essential portion of a liquid crystal display panel according to the first embodiment of the invention.

FIG. 2A shows each drive voltage waveform of the respective portions in the liquid crystal device according to the first embodiment of the invention.

FIG. 2B shows each drive voltage waveform of the respective portions as a modified example of the liquid crystal display device according to the first embodiment of the invention.

FIG. 3 shows each drive voltage waveform of the respective portions in a liquid crystal display device according to a second embodiment of the invention.

FIG. 4A is a chart showing each drive voltage waveform of the respective portions in a liquid crystal display device according to a third embodiment of the invention.

FIG. 4B shows each drive voltage waveform as a modified example of the liquid crystal display device according to the third embodiment of the invention.

FIG. 5A shows each drive voltage waveform of the respective portions in a liquid crystal display device according to a fourth embodiment of the invention.

FIG. 5B shows each drive voltage waveform of the respective portions as a modified example of the liquid crystal display device according to the fourth embodiment of the invention.

FIG. 6 is an equivalent circuit diagram of a pixel structure in a liquid crystal display device according to a fifth embodiment of the invention.

FIG. 7 is an equivalent circuit diagram of a pixel structure of a liquid crystal display device according to a sixth embodiment of the invention.

FIG. 8A is a view schematically showing the structure of a liquid crystal display device according to a seventh embodiment of the invention.

FIG. 8B is an equivalent circuit diagram of the pixel structure of the liquid crystal display device according to the seventh embodiment of the invention.

FIG. 8C is a sectional view schematically showing the structure of the essential portion of the liquid crystal display panel according to the seventh embodiment of the invention.

FIG. 9 shows each drive voltage waveform of the respective portions in a liquid crystal display device according to an eighth embodiment of the invention.

FIG. 10 shows each drive voltage waveform of the respective portions in a liquid crystal display device according to a ninth embodiment of the invention.

FIG. 11 is an equivalent circuit diagram of the image structure of a liquid crystal display device according to a tenth embodiment of the invention.

FIG. 12A shows each drive voltage waveform of the respective portions in the liquid crystal display device according to the tenth embodiment of the invention.

FIG. 12B shows an electrode structure as a modified example of the liquid crystal display device according to the tenth embodiment of the invention.

FIG. 13 is an equivalent circuit diagram of the image structure of a liquid crystal display device according to an eleventh embodiment of the invention.

FIG. 14 shows each drive voltage waveform of the respective portions in the liquid crystal display device according to the eleventh embodiment of the invention.

### DETAILED DESCRIPTION

Embodiments of the invention will be described in detail referring to the drawings.

The element having the same function will be designated with the same reference numeral in the drawings for explaining the embodiments, and the explanation thereof, thus will be omitted.

### First Embodiment

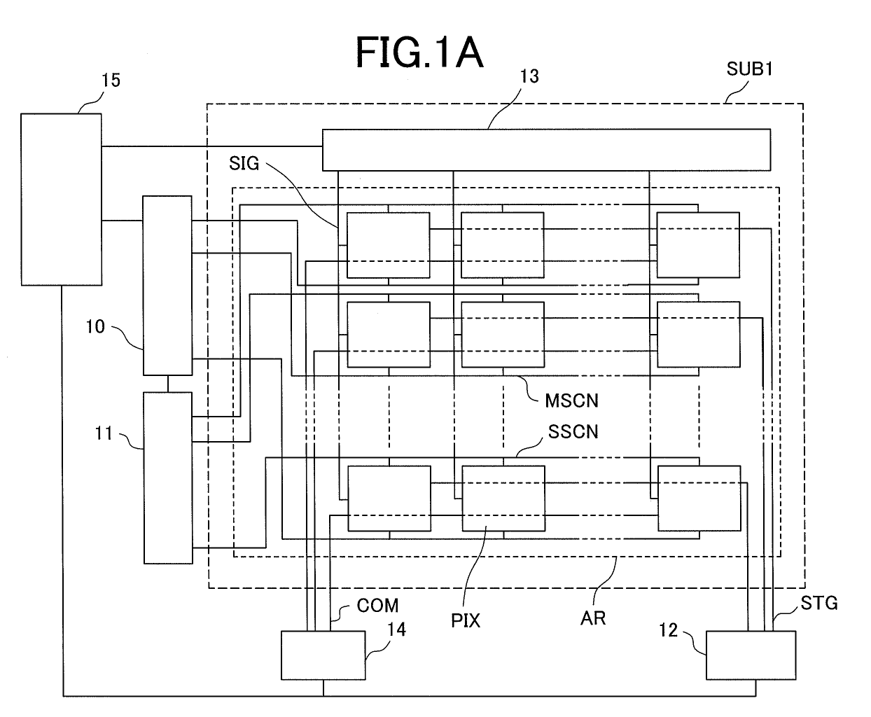

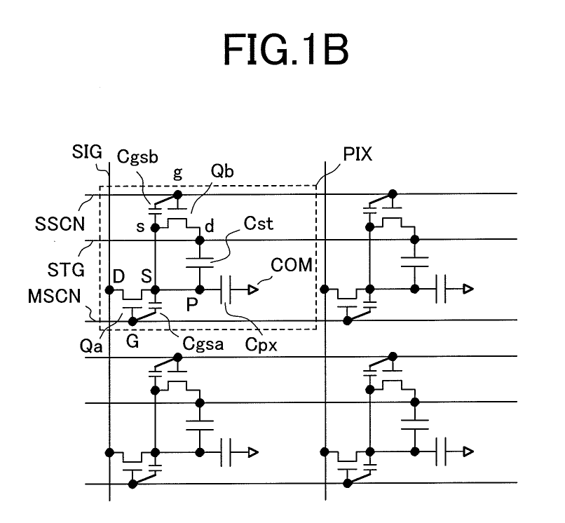

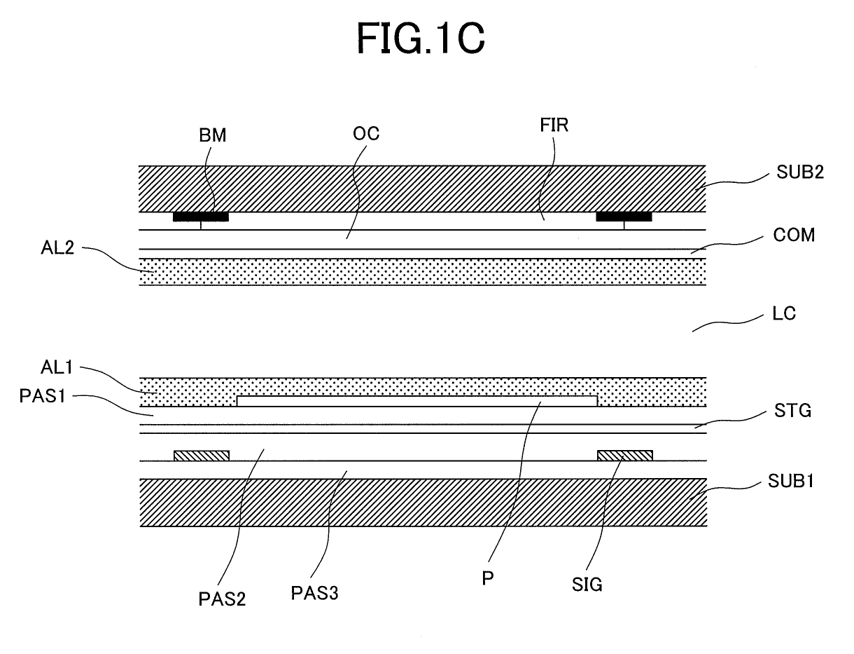

FIG. 1-1 is a view schematically showing the structure of a liquid crystal display device according to a first embodiment of the invention. FIG. 1B is an equivalent circuit diagram of an image structure of the liquid crystal display device according to the first embodiment of the invention. FIG. 1C is a sectional view schematically showing the structure of the essential portion of a liquid crystal display panel according to the first embodiment of the invention.

The liquid crystal display device of this embodiment is of active matrix type using the thin film transistor (TFT). Referring to FIG. 1C, the liquid crystal display panel of the embodiment includes a first substrate SUB1, a second substrate SUB2, and a liquid crystal layer LC interposed between the first substrate SUB1 and the second substrate SUB2. In the embodiment, the second substrate SUB2 is positioned to face the viewer.

A black matrix BM, a color filter FIR, a planar film OC, an opposed electrode COM and an aligned film AL2 are sequentially formed on the second substrate SUB2 toward the liquid crystal layer LC.

A main-scanning wiring MSCN (not shown in FIG. 1-3), a sub-scanning wiring SSCN (not shown in FIG. 1-3), an interlayer insulation film PAS3, a video wiring SIG, an interlayer insulation film PAS2, a retention capacity wiring STG, an interlayer insulation film PAS1, a pixel electrode P and an aligned film AL1 are sequentially formed on the first substrate SUB1 toward the liquid crystal layer LC.

A phase difference plate and a polarization plate (not shown) are provided outside the first and the second substrates SUB1 and SUB2.

In the embodiment, the main-scanning wiring MSCN, the retention capacity wiring STG and the sub-scanning wiring SSCN corresponding to the main-scanning wiring MSCN are provided on the first substrate SUB1 as shown in FIG. 1B. The video wiring SIG is provided to intersect with those wirings. A main thin film transistor Qa and a sub thin film transistor Qb are provided for each sub-pixel PIX defined by the main-scanning wiring MSCN and the video wiring SIG as indicated by a broken line.

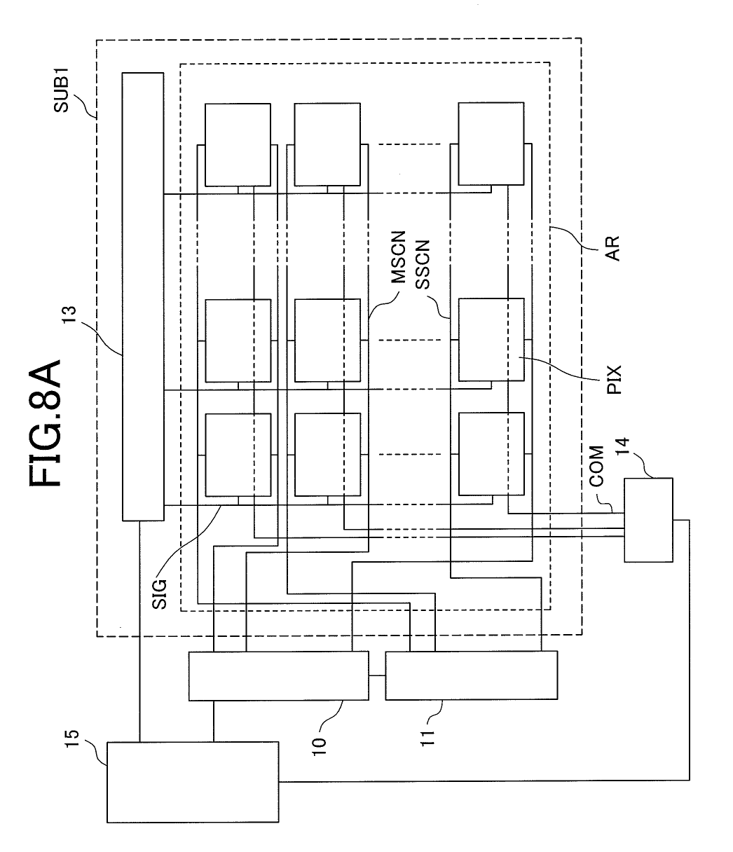

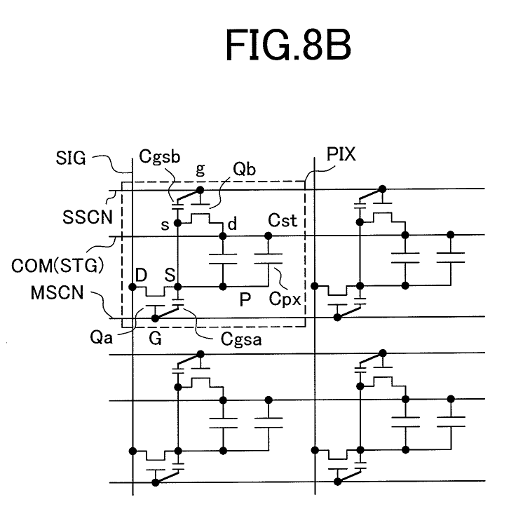

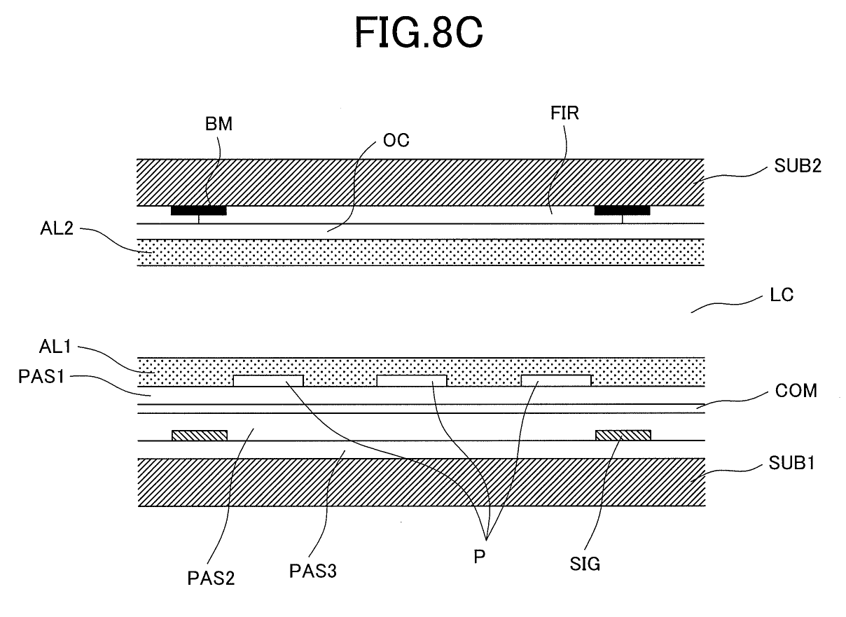

Referring to FIG. 1A, the main-scanning wiring MSCN is connected to a scanning wiring drive circuit 10, the sub-scanning wiring SSCN is connected to a sub-scanning wiring drive circuit 11, the retention capacity wiring STG is connected to a retention capacity voltage generation circuit 12, the video wiring SIG is connected to a video wiring drive circuit 13, and an opposed electrode COM is connected to an opposed voltage generation circuit 14, respectively. A display control circuit 15 is structured to control and drive the scanning wiring drive circuit 10, the sub-scanning wiring drive circuit 11, the retention capacity voltage generation circuit 12, the video wiring drive circuit 13, and the opposed voltage generation circuit 14. An AR denotes a display region as shown in FIGS. 1-1 and 8-1 to be described later.

The main transistor Qa and the sub transistor Qb may employ the amorphous silicon thin film transistor (TFT) using the amorphous silicon (a-Si) as the semiconductor layer, the polysilicon thin film transistor (TFT) using the polysilicon as the semiconductor layer, and the transistor using generally employed crystal silicon as the semiconductor layer.

Each of the drive circuits 10 to 13 which have been already described or will be described later is formed of the semiconductor chip, and is mounted on the first substrate SUB1 or the flexible wiring substrate. Alternatively, each of the drive circuits 10 to 13 may be formed of the polysilicon thin film transistor (TFT) using the polysilicon as the semiconductor layer so as to be formed on the first substrate SUB1 integrally with the main transistor Qa or the sub transistor Qb.

A gate electrode g, a drain electrode d, and a source electrode s of the sub thin film transistor Qb are connected to the sub-scanning wiring SSCN, the retention capacity wiring STG, and a pixel electrode P, respectively.

A gate electrode G, a drain electrode D, and a source electrode S of the main thin film transistor Qa are connected to the main-scanning wiring MSCN, the video wiring STG, and the pixel electrode P, respectively.

A retention capacity Cst is formed between the pixel electrode P and the retention capacity wiring STG via the insulation film (PAS1 shown in FIG. 1C).

The second substrate SUB2 provided with the opposed electrode COM and the first substrate SUB1 are arranged to have the respective electrode forming surfaces facing with each other, and the gap therebetween is filled with the liquid crystal composition to form a pixel capacity Cpx between the pixel electrode P and the opposed electrode COM via the liquid crystal layer LC.

The phase difference plate and the polarization plate (not shown) are provided outside the first and the second substrates to form the liquid crystal display device in the NB display mode.

A parasitic capacity Cgsa is formed between the gate electrode G and the source electrode S of the main thin film transistor Qa. A parasitic capacity Cgsb is formed between the gate electrode g and the source electrode s of the sub thin film transistor Qb.

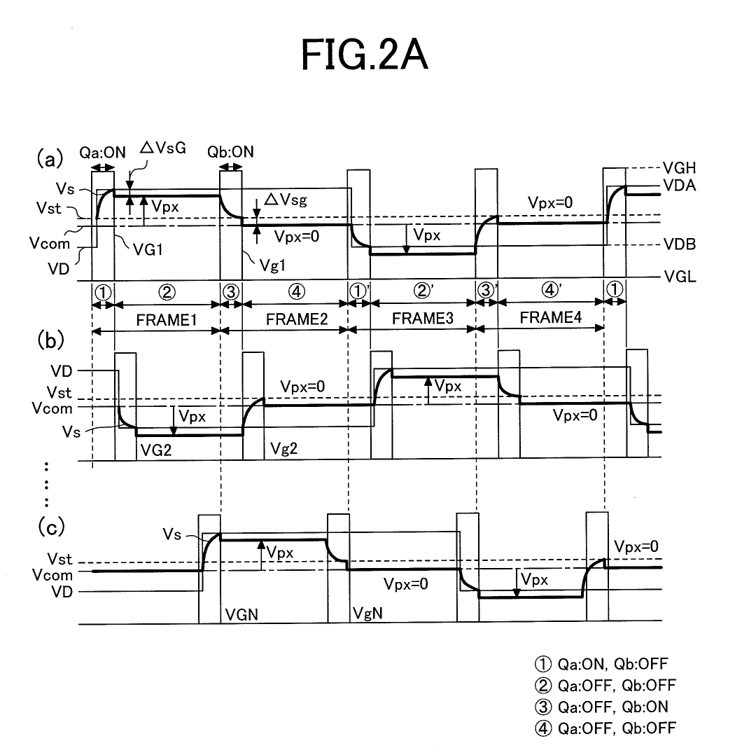

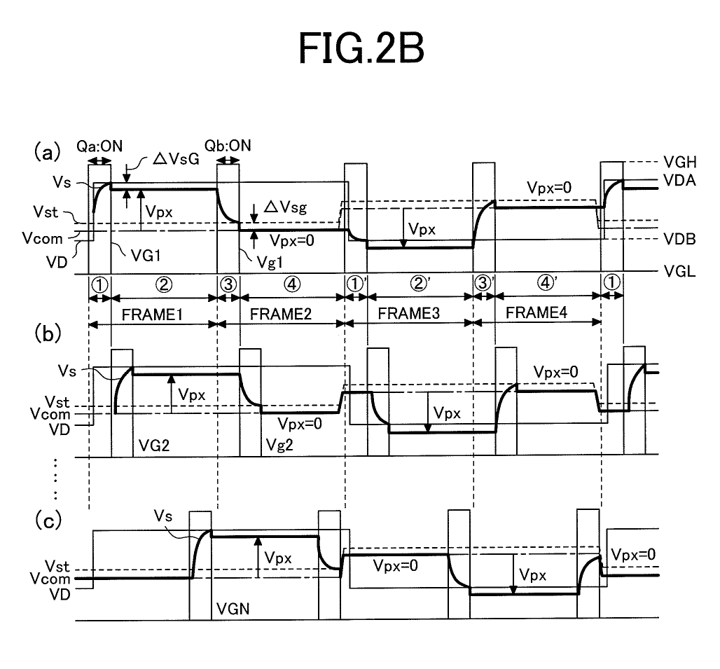

Each drive voltage waveform of the respective portions of the liquid crystal display device according to the embodiment will be shown in FIG. 2A. FIG. 2A(a) shows the drive voltage waveform on the first display line upon start of the screen scanning. FIG. 2A(b) shows the drive voltage waveform on the second display line. FIG. 2A(c) shows the drive voltage waveform on the Nth display line at the end of the screen scanning. The drive voltage waveform is formed of a first frame time where the main-scanning wiring MSCN controls application and holding of the voltage to the pixel electrode P in the sub-pixel PLX, and a second frame time where the sub-scanning wiring SSCN controls the aforementioned operations, which are repeated alternately.

Referring to FIG. 2A(a), VG1 denotes the voltage waveform of the main-scanning wiring MSCN on the first display line at the head of the screen, Vg1 denotes the voltage waveform of the sub-scanning wiring SSCN on the first display line, VD denotes the voltage waveform of the subject video wiring SIG, Vcom denotes the voltage waveform of the opposed electrode COM, Vst denotes the voltage waveform of the retention capacity wiring STG, Vs denotes the voltage waveform of the pixel electrode P of the subject sub-pixel PIX, and Vpx denotes the liquid crystal application voltage applied to the pixel capacity Cpx as the differential voltage between the pixel electrode voltage Vs and the opposed voltage Vcom.

The first frame time on the first display line starts upon the start of screen scanning of the first frame, that is, Frame1. The first frame time is formed of a time section [1] for which the main-scanning wiring MSCN on the first display line is brought into the selective state by controlling the main-scanning wiring voltage VG1 on the first display line to ON voltage (VGH) of the main thin film transistor, and a time section [2] for which the main-scanning wiring MSCN is brought into the non-selective state by controlling the main-scanning wiring voltage VG1 to OFF voltage VGL.

The operation in the embodiment is the same as the driving operation of the generally employed thin film transistor active matrix except that the sub-scanning wiring SSCN on the first display line is brought into the non-selective state while keeping the sub-scanning wiring voltage Vg1 on the first display line at OFF voltage VGL of the sub thin film transistor Qb in the first frame time.

Then the liquid crystal application voltage Vpx corresponding to the image signal is supplied to the pixel capacity Cpx on the first display line to operate the liquid crystal layer LC such that the image is displayed on the sub-pixels on the first display line.

The first frame time is switched to the second frame time formed of the time sections [3] and [4]. In the second frame time, the main-scanning wiring MSCN on the first display line is kept in the non-selective state while keeping the main-scanning wiring voltage VG1 on the first display line at OFF voltage VGL of the main thin film transistor Qa.

In the time section [3], the sub-scanning wiring voltage Vg1 on the first display line is set to ON voltage VGH of the sub thin film transistor Qb to bring the sub-scanning wiring SSCN on the first display line into the selective state. Then the pixel electrode voltage Vs of the entire sub-pixels on the first display line is charged to the retention capacity voltage Vst via the sub thin film transistor Qb.

In the time section 4, when the sub-scanning wiring voltage Vg1 on the first display line is set to OFF voltage VGL of the sub thin film transistor Qb to bring the sub-scanning wiring SSCN on the first display line into the non-selective state, the pixel electrode voltage Vs of the entire sub-pixels on the first display line is reduced by the amount corresponding to the feed through voltage ΔVsg resulting from switching of the sub-scanning wiring voltage Vg1 from ON voltage VGH to OFF voltage VGL, and the parasitic capacity Cgsb of the sub thin film transistor Qb. The aforementioned state is maintained.

$$\begin{matrix}[ Formula 1 ] & \\ \begin{matrix}Vst = Vcom + Δ Vsg \\ = Vcom + \frac{Cgsb}{Cpx + Cst + Cgsa + Cgsb} ( VGH - VGL )\end{matrix} & ( 1 )\end{matrix}$$

As the above formula (1) shows, the retention capacity voltage Vst is set to the value higher than the opposed voltage Vcom supplied to the opposed electrode COM by the amount corresponding to the feed through voltage ΔVsg such that the pixel electrode voltage Vs maintained in the time section [4] becomes equal to the opposed voltage Vcom. This makes it possible to set the liquid crystal application voltage Vpx in the time section [4] to zero.

As the NB display mode is set, black frame insertion may be performed in the entire sub-pixels on the first display line.

The frame time is further switched to the first frame time formed of the time section [1]′ and [2]′. The first frame time at present is the same as the previous first frame time except that the polarity of the voltage VD of the video wiring SIG with respect to the opposed voltage Vcom is reversed. As the polarity of the liquid crystal application voltage Vpx is reversed, the pixel capacity Cpx is AD driven to display the image.

Thereafter, the frame time is switched to the second frame time formed of the time sections [3]′ and [4]′, which is the same as the previous second frame time, and capable of performing the black frame insertion in the entire sub-pixels on the first display line. The aforementioned operations are repeatedly performed to display the image and the black frame alternately.

In the embodiment, the first frame time formed of the time sections [1] and [2] is allocated to the first frame (Frame1), the second frame time formed of the time sections [3] and [4] is allocated to the second frame (Frame2), the first frame time formed of the time sections [1]′ and [2]′ is allocated to the third frame (Frame3), and the second frame time formed of the time sections [3]′ and [4]′ is allocated to the fourth frame (Frame4), respectively. The sub-scanning wiring voltage waveform Vg1 is the same as the main-scanning wiring voltage waveform VG1 except that the timing is different.

Referring to FIG. 2A(b), VG2 denotes the voltage waveform of the main-scanning wiring MSCN on the second display line, and Vg2 denotes the voltage waveform of the sub-scanning wiring SSCN on the second display line. Other codes are the same as those shown in FIG. 2A(a).

The first frame time on the second display line starts at the timing upon switching from the time section [1] to [2] in the first frame time on the first display line. Likewise the case of the first display line, the image corresponding to the image signal is displayed on the respective sub-pixels on the second display line.

The second frame time on the second display line starts at the timing upon switching from the time section [3] to [4] in the second frame time on the first display line. Likewise the case of the first display line, the black frame display may be performed on the entire sub-pixels on the second display line.

Thereafter, the first frame time on the second display line starts again at the timing for switching from the time section [1]′ to [2]′ in the first frame time on the first display line. The second frame time on the second display line starts at the timing for switching from the time section [3]′ to [4]′ in the second frame time on the second display line.

This makes it possible to display the image and the black frame alternately on the second display line likewise on the first display line.

The same operations may be obtained on the third and subsequent display lines. Referring to FIG. 2A(c), VGN denotes the voltage waveform of the main-scanning line MSCN on the Nth display line as the last display line on the screen, and VgN denotes the voltage waveform of the sub-scanning wiring SSCN on the Nth display line. Other codes are the same as those shown in FIG. 2A(a). The correlation of the timing for starting the first and the second frame times on the Nth display line with the timing for switching the previous frame time on the first display line is the same as the case on the second and subsequent display lines. The image and the black frame may be displayed alternately on the Nth display line likewise the case on the first and subsequent display lines.

In the embodiment, after switching from the time section [1] to [2] in the first frame time on the Nth display line (from [1]′ to [2]′), the time section [1] is switched to the time section [2] on the first display line as the head display line on the screen. After switching from the time section [3] to [4] (from [3]′ to [4]′) in the second frame time on the Nth display line, the second frame time is switched to the first frame time on the first display line.

In the aforementioned operation, the image display formed in the first frame time and the black frame formed in the second frame time may be displayed alternately. The black frame may be inserted between the images to improve the video quality.

FIG. 2B shows each drive voltage waveform of the respective portions as the modified example of the liquid crystal display device according to the embodiment. The drive voltage waveform in FIG. 2A shows that the opposed voltage Vcom supplied to the opposed electrode COM is kept constant in the respective frames. The drive voltage waveform in FIG. 2B shows that the opposed voltage Vcom supplied to the opposed electrode COM changes between the positive polarity and the negative polarity in accordance with the polarity of the voltage VD of the video wiring SIG. Other structure is the same as that of the case of the drive voltage waveform shown in FIG. 2A.

FIG. 2B(a) shows the drive voltage waveform on the first display line corresponding to the display line on which the screen scanning starts. FIG. 2B(b) shows the drive voltage waveform on the second display line. FIG. 2B(c) shows the drive voltage waveform on the Nth display line corresponding to the display line on which the screen scanning ends. The invention may be applied to the common AC driving operation.

### Second Embodiment

The liquid crystal display device according to a second embodiment of the invention has the same structure as that of the first embodiment except that the drive voltage waveform is different.

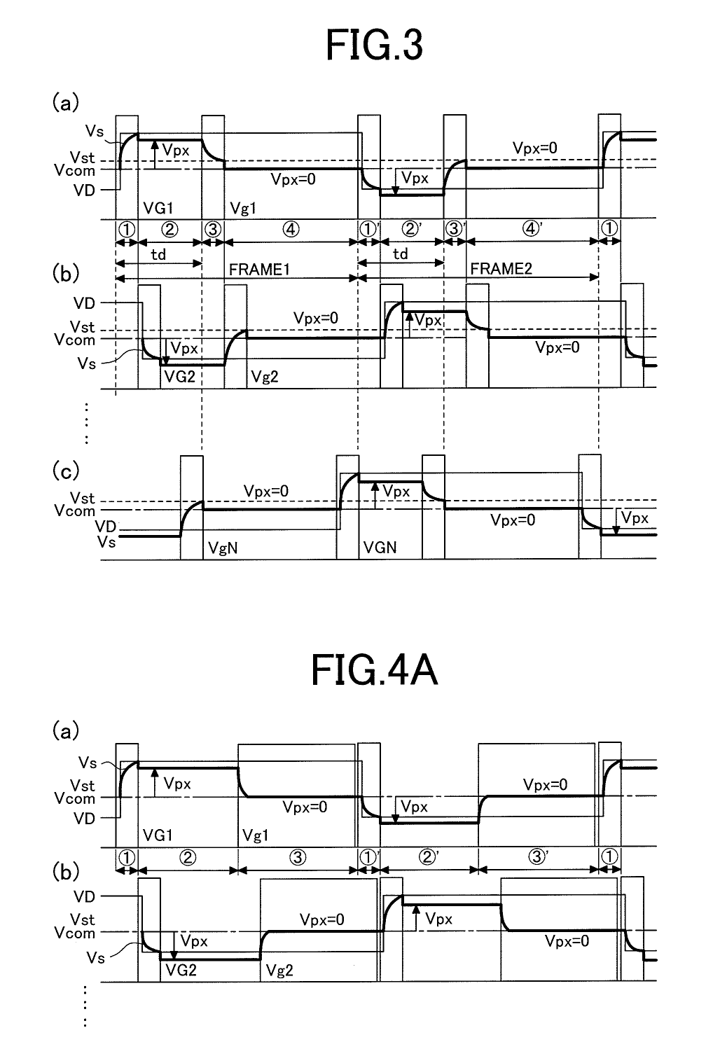

FIG. 3 shows each drive voltage waveform of the respective portions in the liquid crystal display device according to the second embodiment. FIG. 3(a) shows the drive voltage waveform on the first display line where the screen scanning starts. FIG. 3(b) shows the drive voltage waveform on the second display line. FIG. 3(c) shows the drive voltage waveform on the Nth display line where the screen scanning ends. Compared with the first embodiment shown in FIG. 2A, the drive voltage waveform of the embodiment shows the different timing for starting the scanning time.

The explanation will be described referring to FIG. 3(a). The first frame time on the first display line as the head display line on the screen starts upon start of the screen scanning of the first frame (Framre1). In the first frame (Frame1), after an elapse of a delay time td, the time section is switched from [2] to [3] to start the second frame time.

Then as shown in FIG. 3(c), after the screen scanning in the first frame time reaches the Nth display line as the last display line, the screen scanning of the second frame (Frame2) starts, and the first frame time on the first display line starts again. In the second frame (Frame2), after the elapse of the delay time td, the time section is switched from [2]′ to [3]′ to start the second frame time.

The aforementioned operation is the same as the one performed on the second and subsequent display lines as shown in FIGS. 3(b) and 3(c). In other words, the screen scanning performed by the sub-scanning wiring SSCN starts in the middle of the frame time of the respective frames.

In the first embodiment, the first frame is allocated to the first frame time, and the second frame is allocated to the second frame time. Meanwhile in the second embodiment, the first and the second frame time exist in the single frame.

This makes it possible to insert the black frame between the images at the frequency twice higher without changing the length of the frame time, which is effective for further improving the video quality. In the embodiment, the selection time on the display line with respect to the main-scanning wiring and the sub-scanning wiring is substantially the same as the first embodiment. The respective pixel electrode voltages Vs may be sufficiently charged to the desired voltage values while keeping the main thin film transistor Qa and the sub thin film transistor Qb on the respective display lines in ON state. This makes it possible to suppress the brightness gradient or uneven display without increasing the output voltage from the drive circuit and the power consumption.

The black frame may be inserted between the images at the frequency twice higher while keeping the frame frequency the same as that of the first embodiment. The operation frequency for the entire drive circuit does not have to be increased, thus allowing the black frame insertion with the apparently raised frame frequency without increasing the power consumption.

The length of the second frame time is not necessarily the same as that of the first frame time. The delay time td may be set to the desired value such that the length of the second frame time becomes shorter than that of the first frame time. The time for displaying the inserted black frame may be reduced to be shorter than the one for displaying the image. This makes it possible to suppress deterioration in the display brightness.

The delay time td may be determined in accordance with the responsiveness of the liquid crystal layer, the desired video performance and the display brightness. Conversely, the length of the second frame time may be made longer than that of the first frame time to extend the time for displaying the inserted black frame to be longer than the image display time.

### Third Embodiment

The liquid crystal display device according to the third embodiment of the invention has the same structure as that of the first or the second embodiment except that the drive voltage waveform is different.

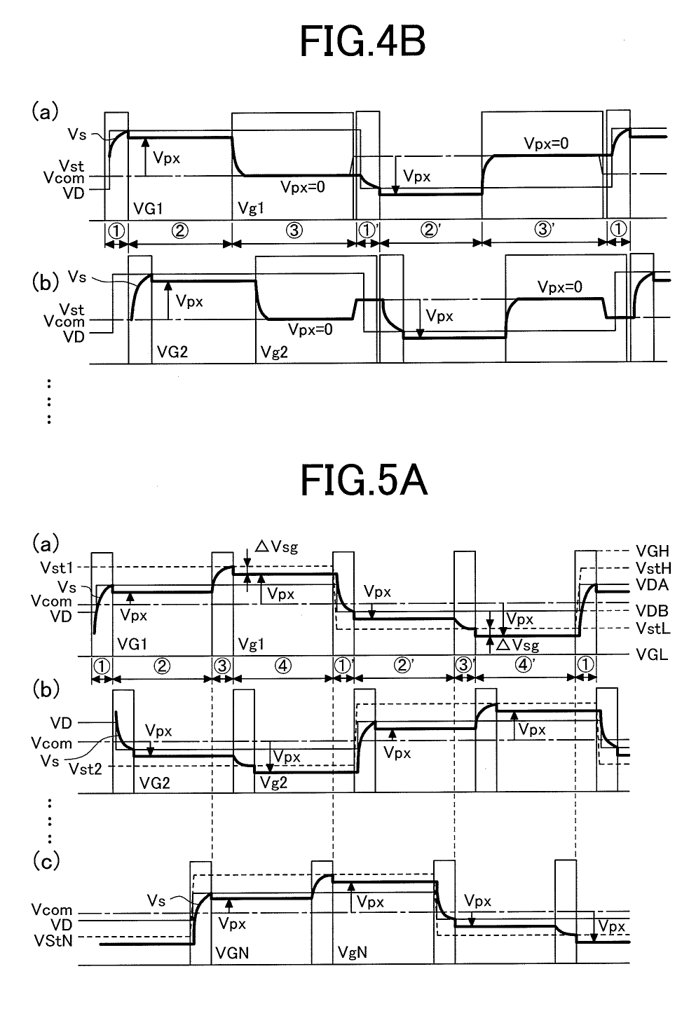

FIG. 4A shows each drive voltage waveform of the respective portions in the liquid crystal display device of the third embodiment. FIG. 4A(a) shows the drive voltage waveform on the first display line upon start of the screen scanning. FIG. 4A(b) shows the drive voltage waveform on the second display line.

The embodiment is different from the first embodiment shown in FIG. 2A and the second embodiment shown in FIG. 3. Specifically, in the second frame time of the embodiment formed only of the time section [3] and [3]′, the sub thin film transistor Qb is kept in ON state while keeping the sub-scanning wiring SSCN on the respective display lines in the selective state.

### [Formula 2]

Vst=Vcom (2)

As the aforementioned formula (2) shows, the retention capacity voltage Vst is made equivalent to the opposed voltage Vcom.

Referring to FIG. 4A(a), in the second frame time on the first display line, the sub-scanning wiring voltage Vg1 on the first display line is set to ON voltage VGH of the sub thin film transistor Qb to bring the sub-scanning wiring SSCN on the first display line into the selective state. Then the pixel electrode voltage Vs of the entire sub-pixels on the first display line is charged to the retention capacity voltage Vst equal to the opposed voltage Vcom via the sub thin film transistor Qb. The aforementioned state is held until the first frame time on the first display line is started again.

In the second frame time, as the sub thin film transistor Qb is not switched from ON state to OFF state, the decrease in the pixel electrode voltage Vs owing to the feed through voltage ·Vsg to the pixel electrode voltage Vs resulting from switching of the sub-scanning wiring voltage Vg1 from ON voltage VGH to OFF voltage VGL, and the parasitic capacity Cgsb of the sub thin film transistor Qb does not have to be considered.

The pixel electrode voltage Vs on the first display line may be controlled to be equal to the opposed voltage Vcom, setting the liquid crystal application voltage Vpx to zero in the second frame time.

Referring to FIG. 4A(b), the driving operation on the second and subsequent display lines is the same as that on the first display line.

In the second frame time, when the sub thin film transistor Qb is brought into ON state while controlling the sub-scanning wiring SSCN into the selective state, the retention capacity voltage Vst has to be supplied to all the sub-pixels on the display line through the retention capacity wiring STG.

FIG. 4B shows each drive voltage wavelength of the respective portions as the modified example of the liquid crystal display device of the embodiment. The drive voltage waveform in FIG. 4A shows the constant opposed voltage Vcom supplied to the opposed electrode COM for the respective frames. The drive voltage waveform in FIG. 4B shows that the opposed voltage Vcom supplied to the opposed electrode COM changes between the positive state and the negative state depending on the polarity of the voltage VD of the image wiring SIG. The other structure is the same as the drive voltage waveform shown in FIG. 4A.

FIG. 4B(a) shows the drive voltage waveform on the first display line for starting the screen scanning. FIG. 4B(b) shows the drive voltage waveform on the second display line. Likewise the aforementioned modified example of the first embodiment, the invention may be applied to the common AC driving.

The embodiment allows the time for keeping the sub thin film transistor Qb in ON state to be made sufficiently longer compared with the first or the second embodiment. The respective pixel electrode voltages Vs may be sufficiently charged to the retention capacity voltage Vst, that is, the opposed voltage Vcom. This makes sure to display the black frame reliably.

In the first to the third embodiments, the respective retention capacity wirings STG may be commonly or independently provided. However, preferably, it is commonly provided in view of the reduction in the resistance of the retention capacity wiring STG.

In the first to the third embodiments, the vertical aligned (VA) mode or the twisted nematic (TN) mode of birefringence type may be employed as the NB display mode.

The pixel structure such as the transmission type, the reflection type, partially transmission reflection type (semi-transmission type) or the alignment division mode may be employed. The use of the active matrix type liquid crystal display device in the NB display mode with the retention capacity wiring STG besides the opposed electrode (COM) may be effective for substantially all the display modes.

### Fourth Embodiment

The equivalent circuit of the pixel structure in the liquid crystal display device according to a fourth embodiment of the invention is the same as the one of the first embodiment shown in FIG. 1 except that the liquid crystal display device in the NW display mode is structured to have different polarizing directions of the phase difference plate and the polarization plate (not shown) provided outside the first substrate SUB1 and the second substrate SUB2 for independently controlling the respective retention capacity wirings STG.

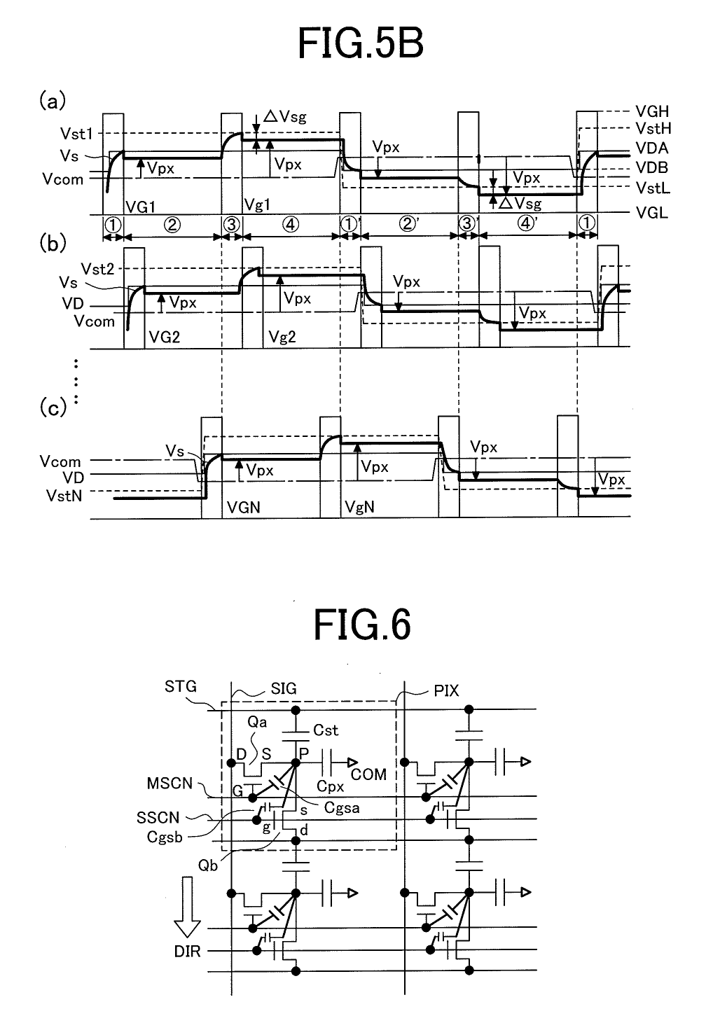

FIG. 5A shows each drive voltage waveform of the respective portions of the liquid crystal display device according to the fourth embodiment. FIG. 5A(a) shows the drive voltage waveform on the first display line upon the start of the screen scanning. FIG. 5A(b) shows the drive voltage waveform on the second display line. FIG. 5A(c) shows the drive voltage waveform on the Nth display line at the end of the screen scanning.

FIGS. 5-1(a), (b) and (c) show the waveforms corresponding to those shown in FIGS. 2-1(a), (b) and (c). However, each retention capacity voltage waveform on the respective display lines is independently changed into Vst1, Vst2 and Vst3, respectively.

Referring to FIG. 5A(a), in the first frame time formed of the time sections [1] and [2], the retention capacity voltage Vst1 on the first display line is held at constant voltage of VstH. This may prevent generation of the feed through voltage applied to the pixel electrode voltage Vs through the retention capacity Cst.

Then the frame time is switched to the second frame time formed of the time sections [3] and [4] while holding the retention capacity voltage Vst1 at VstH. In the second frame time, the main-scanning wiring voltage VG1 on the first display line is kept OFF voltage VGL of the main thin film transistor Qa to keep the main-scanning wiring MSCN on the first display line in the non-selective state.

In the time section [3], the sub-scanning wiring voltage Vg1 on the first display line is set to ON voltage VGH of the sub thin film transistor Qb to bring the sub-scanning wiring SSCN on the first display line in the selective state. Then the pixel electrode voltage Vs of the entire sub-pixels on the first display line may be charged to the retention capacity voltage Vst1, that is, VstH via the sub thin film transistor Qb.

In the time section [4], the sub-scanning wiring voltage Vg1 on the first display line is set to OFF voltage VGL of the sub thin film transistor Qb to bring the sub-scanning wiring SSCN on the first display line into the non-selective state. Then the pixel electrode voltage Vs of the entire sub-pixels on the first display line is decreased by the amount corresponding to the feed through voltage ·Vsg resulting from switching of the sub-scanning voltage Vg1 from ON voltage VGH to OFF voltage VGL, and the parasitic capacity Cgsb of the sub thin film transistor Qb. The aforementioned state is maintained.

The retention capacity voltage Vst1 is preliminarily set such that the liquid crystal application voltage Vpx as the difference between the pixel voltage Vs and the opposed voltage Vcom becomes the value substantially corresponding to the black frame display voltage in the NW display mode. Thereafter, as the first frame time starts, the retention capacity voltage Vst1 is changed to the voltage of VstL at different voltage level inverse to the opposed voltage Vcom.

The frame time is switched to the second frame time formed of the time sections [3]′ and [4]′ while holding the retention capacity voltage Vst1 at the voltage of VstL. In the time section [3]′, the sub-scanning wiring voltage Vg1 on the first display line is set to ON voltage VGH of the sub thin film transistor Qb to bring the sub-scanning wiring SSCN on the first display line into the selective state. The pixel electrode voltage Vs of the entire sub-pixels on the first display line may be charged to the retention capacity voltage Vst1, that is, VstL via the sub thin film transistor Qb.

In the time section [4]′, the sub-scanning wiring voltage Vg1 on the first display line is set to OFF voltage VGL of the sub thin film transistor Qb to bring the sub-scanning wiring SSCN on the first display line into the non-selective state. Then the pixel electrode voltage Vs of the entire sub-pixels on the first display line is decreased by the amount corresponding to the feed through voltage ·Vsg resulting from switching of the sub-scanning wiring voltage Vg1 from ON voltage VGH to OFF voltage VGL, and the parasitic capacity Cgsb of the sub thin film transistor Qb. The aforementioned state is maintained.

The retention capacity voltage Vst1 is set such that the liquid crystal application voltage Vpx becomes the value corresponding to the black frame display voltage in the NW display mode, which has the polarity inverse to that of the liquid crystal application voltage Vpx in the previous second frame time.

Two voltage levels of the retention capacity voltage Vst, that is, VstH and VstL may be set such that the following formula (3) is established, and the liquid crystal application voltage Vpx shown in the formula (4) becomes the value substantially corresponding to the black frame display voltage in the NW display mode.

$$\begin{matrix}[ Formula 3 ] & \\ \frac{VstH + VstL}{2} = Vcom + \frac{Cgsb}{Cpx + Cst + Cgsa + Cgsb} ( VGH - VGL ) & ( 3 ) \\ [ Formula 4 ] & \\ Vpx = \frac{VstH - VstL}{2} & ( 4 )\end{matrix}$$

In the second frame time, the black frame display may be performed for the entire sub-pixels on the first display line. This makes it possible to AC drive the pixel capacity Cpx in case of the black frame insertion display in the NW display mode. The aforementioned operation is the same as the one performed on the second and subsequent display lines as shown in FIGS. 5-1(b) and (c).

As the retention capacity voltages Vst2 and VstN are changed accompanied with switching of the frame time from the second frame time to the first frame time on the respective display lines, the respective retention capacity wirings STG may be independently controlled.

This makes it possible to display the images and the black frames alternately even in the NW display mode, thus improving the video quality by inserting the black frame between the images.

FIG. 5B shows each drive voltage waveform of the respective portions as the modified example of the liquid crystal display device of the embodiment. The drive voltage waveform in FIG. 5A shows that the opposed voltage Vcom supplied to the opposed electrode COM is kept constant in the respective frames. The drive voltage waveform in FIG. 5B shows that the opposed voltage Vcom supplied to the opposed electrode COM changes between positive and negative polarities depending on the polarity of the voltage VD of the video line SIG. Other structure is the same as the one shown by the drive voltage waveform in FIG. 5A.

FIG. 5B(a) shows the drive voltage waveform on the first display line upon start of screen scanning. FIG. 5B(b) shows the drive voltage waveform on the second display line. FIG. 5B(c) shows the drive voltage waveform on the Nth display line at the end of the screen scanning. Likewise the modified examples of the first and the third embodiments, the invention is applicable to the common AC drive in the NW display mode.

If the NW display mode is set, the driving operation may be performed for starting screen scanning by the sub-scanning wiring SSCN in the middle of the single frame time like the second embodiment. The resultant effect derived from the aforementioned driving is also the same as the one derived from the second embodiment.

The driving operation may be performed for keeping the sub-scanning wiring SSCN on the respective display lines in the selective state in the second frame time like the third embodiment. The resultant effect is also the same as the one derived from the third embodiment.

In the embodiment, the retention capacity voltage Vst on the respective display line is changed in synchronization with switching of the frame time from the second frame time to the first frame time on the display line. It may be changed accompanied with the switching from the first frame time to the second frame time so long as it is kept substantially constant in the respective scanning periods.

As the NW display mode, the TN mode twisted at 90°, ECB mode with homogenous alignment, and OCB mode may be employed in the embodiment. Alternatively, the pixel structure of the transmission type, reflection type, partial transmission-reflection type (semi-transmission type) or the alignment division mode may be employed. The active matrix type liquid crystal display device with NW display mode using the retention capacity wiring STG besides the opposed electrode COM may be effective for substantially all the display modes.

The embodiment is applicable to the NB display mode. In this case, two voltage levels of the retention capacity voltage Vst, that is, VstH and VstL may be set such that the aforementioned formula (3) is established, and the liquid crystal application voltage Vpx in the time sections [4] and [4]′ becomes the value substantially corresponding to the black frame display voltage in the NB display mode as indicated by the formula (4).

In the first to the fourth embodiments, the retention capacity Cst is formed between the pixel electrode P and the retention capacity wiring STG via the insulation film. It may be formed between the source electrode S of the main thin film transistor Qa and the retention capacity wiring STG via the insulation film, or formed between the source electrode s of the sub thin film transistor Qb and the retention capacity wiring STG via the insulation film. It may be formed by combining the aforementioned processes.

### Fifth Embodiment

The liquid crystal display device according to a fifth embodiment of the invention has the different pixel structure from that of each of the liquid crystal display devices according to the first to the fourth embodiments.

FIG. 6 shows the equivalent circuit in the pixel structure of the liquid crystal display device according to the fifth embodiment of the invention, which has features different from those of the first embodiment shown in FIG. 1B.

Specifically, the drain electrode d of the sub thin film transistor Qb of the subject sub-pixel PIX is connected to the retention capacity wiring STG of the sub-pixel adjacent to the side of the subject sub-pixel PIX to be subsequently scanned in the screen scanning direction DIR.

The dummy sub-pixel or the dummy retention capacity wiring STG may be provided as the display line adjacent to the side to be subsequently scanned in the screen scanning direction DIR so as to connect the drain electrode d of the sub thin film transistor Qb in the sub-pixel on the pixel last display line where the screen scanning ends.

### Sixth Embodiment

The liquid crystal display device according to the sixth embodiment of the invention has the different pixel structure from those of the liquid crystal display devices according to the first to the fourth embodiments.

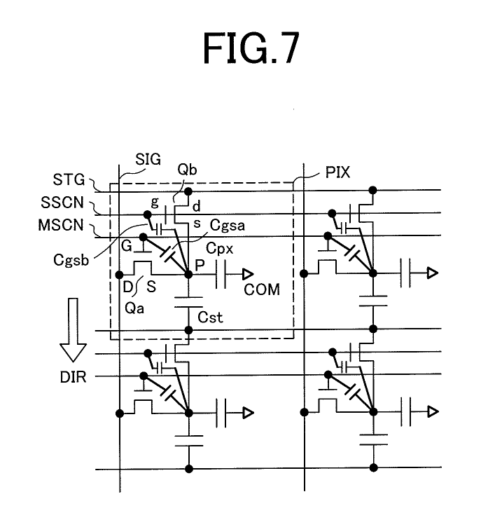

FIG. 7 shows the equivalent circuit of the pixel structure in the liquid crystal display device according to the sixth embodiment of the invention, which is different from that of the first embodiment shown in FIG. 1B.

Specifically, the drain electrode d of the sub thin film transistor Qb of the subject sub-pixel PIX is connected to the retention capacity wiring STG of the sub-pixel adjacent to the side of the subject sub-pixel PIX previously scanned in the screen scanning direction DIR.

The screen head display line where the screen scanning starts is set by providing the dummy sub-pixel or the dummy retention capacity wiring STG as the display line adjacent to the side previously scanned in the screen scanning direction DIR to connect the drain electrode d of the sub thin film transistor Qb in the sub-pixel on the screen head display line.

The drive voltage waveform according to the first to the fourth embodiments in accordance with the liquid crystal display mode to be employed is applicable to the drive method described in the fifth and the sixth embodiments. The resultant effects are the same as those described in the first to the fourth embodiments.

### Seventh Embodiment

Each of a seventh embodiment and eighth to tenth embodiments provides the liquid crystal display device in IPS display mode.

FIG. 8A schematically shows the structure of the liquid crystal display device according to the seventh embodiment of the invention. FIG. 8B shows the equivalent circuit in the pixel structure of the liquid crystal display device of the seventh embodiment of the invention. FIG. 8C is a sectional view schematically showing the structure of the essential portion of the liquid crystal display panel according to the seventh embodiment of the invention.

The liquid crystal display device of the embodiment is of active matrix type using the thin film transistor (TFT). Referring to FIG. 8C, the liquid crystal display panel of the embodiment includes the first substrate SUB1, the second substrate SUB2, and the liquid crystal layer LC interposed therebetween. In the embodiment, the second substrate SUB2 is positioned to face the viewer.

The black matrix BM, the color filter FIR, the planar film OC and the alignment film AL2 are formed on the second substrate SUB2 toward the liquid crystal layer LC.

The main-scanning wiring MSCN (not shown in FIG. 8C), the sub-scanning wiring SSCN (not shown in FIG. 8C), the interlayer insulation film PAS3, the video wiring SIG, the interlayer insulation film PAS2, the opposed electrode COM, the interlayer insulation film PAS1, the pixel electrode P and the alignment film AL1 are sequentially formed toward the liquid crystal layer LC.

The phase difference plate and the polarization plate (not shown) are provided outside the first substrate SUB1 and the second substrate SUB2.

As shown in FIG. 8B, the main-scanning wiring MSCN, the opposed electrode COM serving as the retention capacity wiring and the sub-scanning wiring SSCN corresponding to the main-scanning wiring MSCN are provided on the first substrate SUB1. The video wiring SIG is also provided to intersect with those wirings. As indicated by the broken line, the main thin film transistor Qa and the sub thin film transistor Qb are provided in each of the sub-pixels PIX defined by the main-scanning wiring MSCN and the video wiring SIG.

Referring to FIG. 8A, the main-scanning wiring MSCN is connected to the scanning wiring drive circuit 10. The sub-scanning wiring SSCN is connected to the sub scanning wiring drive circuit 11. The video wiring SIG is connected to the video wiring drive circuit 13. The opposed electrode COM is connected to the opposed voltage generation circuit 14.

The gate electrode g, the drain electrode d, and the source electrode s of the sub thin film transistor Qb are connected to the sub-scanning wiring SSCN, the opposed electrode COM, and the pixel electrode P, respectively.

The gate electrode G, the drain electrode D, and the source electrode S of the main thin film transistor Qa are connected to the main-scanning wiring MSCN, the video wiring SIG, and the pixel electrode P, respectively.

The pixel electrode P with the strip-like or comb-like planar shape is formed to have the electrode arrangement with the IPS structure having the pixel capacity Cps by generating the electric field in parallel with the surface of the first substrate SUB1 between the pixel electrode P and the opposed electrode COM via the liquid crystal layer LC. The retention capacity Cst is formed between the pixel electrode P and the opposed electrode COM via the insulation film (PAS1 shown in FIG. 8C).

The phase difference plate and the polarization plate (not shown) are provided outside the first and the second substrates to form the liquid crystal display device in the NB display mode.

The parasitic capacity Cgsa is formed between the gate electrode G and the source electrode S of the main thin film transistor Qa, and the parasitic capacity Cgsb is formed between the gate electrode g and the source electrode s of the sub thin film transistor Qb.

As the liquid crystal display device of the embodiment has the opposed electrode COM serving as the retention capacity wiring. Accordingly, the retention capacity voltage Vst is equal to the opposed voltage Vcom supplied to the opposed electrode. It may be driven with the drive voltage waveform which is the same as the one described in the third embodiment. The black frame insertion according to the invention may be performed even in the IPS display mode, and the resultant effects are the same as those derived from the other embodiments.

The respective opposed electrodes COM may be commonly or independently controlled. However, it is preferable to commonly control those opposed electrodes for the purpose of reducing the resistance of the opposed electrodes COM.

### Eighth Embodiment

The liquid crystal display device according to the eighth embodiment of the invention is substantially the same as that of the seventh embodiment except that the drive voltage waveform is different.

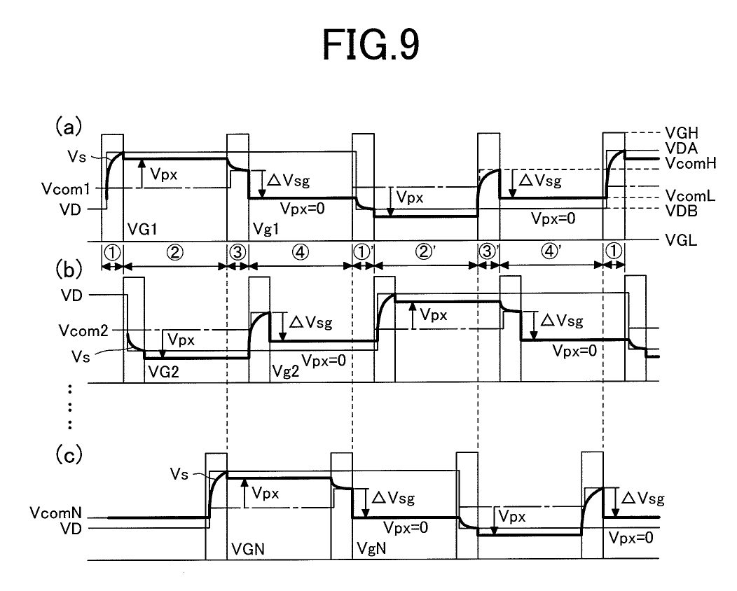

FIG. 9 shows each drive voltage waveform of the respective portions in the liquid crystal display device of the embodiment. FIG. 9(a) shows the drive voltage waveform on the first display line. FIG. 9(b) shows the drive voltage waveform on the second display line. FIG. 9(c) shows the drive voltage waveform on the Nth display line.

Likewise the first and the second embodiments, the second frame time is formed of the time sections [3] ([3]′) and [4] ([4]′) for which the sub-scanning wiring SSCN is brought into the selective state and the non-selective state, respectively while keeping the main-scanning wiring MSCN in the non-selective state.

The Vcom1 denotes the voltage waveform of the opposed electrode COM on the first display line, Vcom2 denotes the voltage waveform of the opposed electrode COM on the second display line, and VcomN denotes the voltage waveform of the opposed electrode COM on the Nth display line, respectively. Those opposed electrodes COM are independently controlled.

Referring to FIG. 9(a), after the elapse of the first frame time formed of the time sections [1] and [2], the frame time is switched to the second frame time formed of the time sections [3] and [4].

In the second frame time, the main-scanning wiring MSCN on the first display line is brought into the non-selective state while keeping the main-scanning wiring voltage VG1 on the first display line at OFF voltage VGL of the main thin film transistor Qa. In the second frame time on the first display line, the opposed voltage Vcom1 supplied to the opposed electrode on the first display line is increased to be higher than the value in the first frame time to the voltage of VcomH in synchronization with the start of the time section [3]. It is decreased to the voltage of VcomL in synchronization with switching of the time section to [4].

In the time section [3], the sub-scanning wiring voltage Vg1 on the first display line is set to ON voltage VGH of the sub thin film transistor Qb to bring the sub-scanning wiring SSCN on the first display line into the selective state. Then the pixel electrode voltage Vs of the entire sub-pixels on the first display line is charged to the opposed voltage VcomH supplied to the opposed electrode COM after the increase.

In the time section [4], the sub-scanning wiring voltage Vg1 on the first display is set to OFF voltage VGL of the sub thin film transistor Qb to bring the sub-scanning wiring on the first display line into the non-selective state. The pixel electrode voltage Vs of the entire sub-pixels on the first display line is decreased by the amount corresponding to the feed through voltage ΔVps resulting from the change of the sub-scanning wiring voltage Vg1 from ON voltage (VGH) to OFF voltage VGL and the parasitic capacity Cgsb, and the feed through voltage ΔVps resulting from the decrease in the opposed voltage Vcom1 supplied to the opposed electrode on the first display line from VcomH to VcomL, the pixel capacity Cpx and the retention capacity Cst. The aforementioned state is maintained.

The voltage of the VcomL obtained after lowering the opposed voltage Vcom1 supplied to the opposed electrode COM may be preliminarily set relative to the value VcomH obtained before lowering as shown in the formula (5). This allows the difference between the pixel electrode voltage Vs maintained in the time section [4] and the opposed voltage Vcom1, that is, VcomL to become zero.

$$\begin{matrix}[ Formula 4 ] & \\ VcomL = VcomH - \frac{Cgsb}{Cgsa + Cgsb} ( VGH - VGL ) & ( 5 )\end{matrix}$$

The liquid crystal application voltage Vpx in the entire sub-pixels on the first display line becomes zero to allow the black frame display.

Thereafter, the opposed voltage Vcom1 is returned to the value in the first frame time again in synchronization with switching of the frame time from the second frame time to the first frame time. When the frame time is further switched to the second frame time to start the time section [3]′, the driving operation is performed in the same way. The aforementioned operations are the same as those to be performed on the second and subsequent lines as shown in FIGS. 9(b) and 9(c).

The embodiment allows the image and the black frame to be displayed alternately. This makes it possible to insert the black frame between the images, thus improving the video quality.

In the embodiment, the opposed voltage Vcom is once increased when switching of the time section from [2] to [3], and is decreased when switching of the time section from [3] to [4]. When the feed through voltage to the pixel electrode voltage Vs is sufficiently low when switching the time section from [3] to [4], it does not have to be increased when switching the time section from [2] to [3].

### Ninth Embodiment

The liquid crystal display device according to the ninth embodiment is substantially the same as that of the seventh embodiment except that the drive voltage waveform is different.

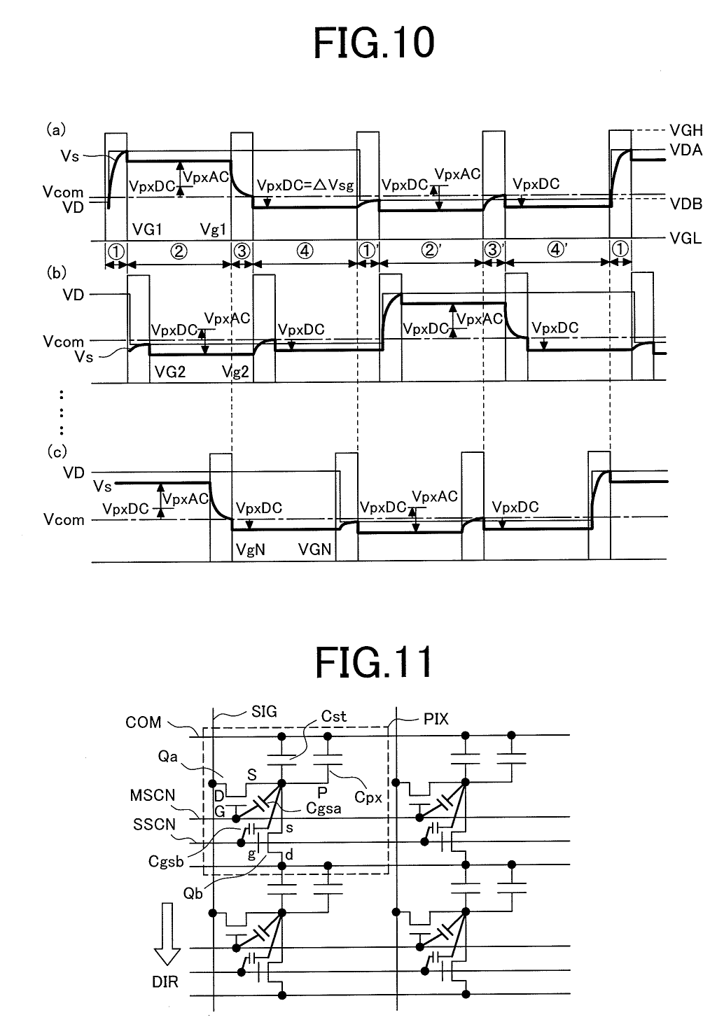

FIG. 10 shows each drive voltage waveform of the respective portions in the liquid crystal display device according to the embodiment. FIG. 10(a) shows the drive voltage waveform on the first display line. FIG. 10(b) shows the drive voltage waveform on the second display line. FIG. 10(c) shows the drive voltage waveform on the Nth display line.

Likewise the first and the second embodiments, the second frame time is formed of the time sections [3] ([3]′) and [4] ([4]′) for which the sub-scanning wiring SSCN is brought into the selective state and the non-selective state, respectively while keeping the main-scanning wiring MSCN in the non-selective state.

The Vcom denotes the voltage waveform of the opposed electrode COM. Unlike the eighth embodiment shown in FIG. 9, the opposed voltage Vcom supplied to the opposed electrode is kept constant.

Referring to FIG. 10(a), after the elapse of the first frame time formed of the time sections [1] and [2], the frame time is switched to the second frame time formed of the time sections [3] and [4].

In the second frame time, the main-scanning wiring MSCN on the first display line is brought into the non-selective state while keeping the main-scanning wiring voltage VG1 on the first display line at OFF voltage VGL of the main thin film transistor Qa. In the time section [3] of the second frame time on the first display line, the sub-scanning wiring voltage Vg1 on the first display line is set to ON voltage VGH of the sub thin film transistor Qb to bring the sub-scanning wiring SSCN on the first display line into the selective state. Then the electrode voltage Vs of the entire sub-pixels on the first display line is charged to the opposed voltage Vcom to the opposed electrode COM via the sub thin film transistor Qb.

In the time section [4], the sub-scanning wiring voltage Vg1 on the first display line is set to OFF voltage VGL of the sub thin film transistor Qb to bring the sub-scanning wiring SSCN on the first display line into the non-selective state. Then the pixel electrode voltage Vs of the entire sub-pixels on the first display line is decreased by the amount corresponding to the feed through voltage ·Vsg resulting from the change in the sub-scanning wiring voltage Vg1 from ON voltage VGL to OFF voltage VGL, and the parasitic capacity Cgsb of the sub thin film transistor Qb. The aforementioned state is maintained.

Although the difference between the pixel voltage Vs and the opposed voltage Vcom, that is, the liquid crystal application voltage Vpx is no longer zero as shown in the formula (6), the respective capacity values are set such that the value becomes smaller than the black frame display voltage in the IPS display mode as the NB display mode.

$$\begin{matrix}[ Formula 5 ] & \\ Vpx = VpxDC = - \frac{Cgsb}{Cpx + Cst + Cgsa + Cgsb} ( VGH - VGL ) < 0 & ( 6 ) \\ \frac{VDA + VDB}{2} = Vcom + \frac{Cgsa + Cgsb}{Cpx + Cst + Cgsa + Cgsb} ( VGH - VGL ) & ( 7 )\end{matrix}$$

As the same operation is performed in the second frame time again, the liquid crystal application voltage Vpx appears to be always the negative DC voltage to DC drive the pixel capacity Cpx in view of only the second frame time with the black frame.

In order to compensate the DC voltage component, the DC voltage (VpxDC shown in FIG. 10) with inverse polarity is superimposed with the image signal (VpxAC shown in FIG. 10) in the first frame time for displaying the image. Then the correlation between the opposed voltage Vcom and the voltage VD of the video wiring SIG is set such that the DC voltage component in the liquid crystal application voltage Vpx becomes zero when observing through both the first and the second frame times. The correlation is represented by the formula (7). In the formula (7), the VDA and VDB denote the voltages of the video wiring SIG in the time sections [1] and [1]′, respectively.

The aforementioned operations are the same as those performed on the second and subsequent display lines as shown in FIGS. 10(b) and 10(c).

The embodiment allows the image and the black frame to be displayed alternately. This makes it possible to insert the black frame between the images to improve the video quality. The opposed electrode COM may be controlled commonly or independently. However, it is preferable to control the opposed electrodes commonly for the purpose of reducing the resistance of the opposed electrode.

The seventh to the ninth embodiments may be structured to drive the sub-scanning wiring SSCN to start screen scanning in the middle of the single frame likewise the second embodiment. The resultant effects are the same as those derived from the second embodiment.

Among the seventh to the ninth embodiments, the seventh embodiment is the most preferable structure because the liquid crystal display device is structured to commonly control the opposed electrode COM, thus providing the simple drive voltage waveform, and less severe limitation of the capacity value to allow the black frame insertion.

### Tenth Embodiment

The liquid crystal display device according to the tenth embodiment of the invention is another embodiment of the one in the IPS display mode. FIG. 1A shows the equivalent circuit of the pixel structure of the liquid crystal display device according to the tenth embodiment of the invention.

The embodiment provides the liquid crystal display device of active matrix type using the thin film transistor. In the embodiment, the main-scanning wiring MSCN, the opposed electrode COM serving as the retention capacity wiring and the sub-scanning wiring SSCN corresponding to the main-scanning wiring MSCN are formed on the first substrate SUB1 as well as the video wiring SIG intersecting therewith. The main thin film transistor Qa and the sub thin film transistor Qb are provided in each of the sub-pixels PIX defined by the main-scanning wiring MSCN and the video wiring SIG.

The gate electrode g, the drain electrode d, and the source electrode s of the sub thin film transistor Qb are connected to the sub-scanning wiring SSCN, the opposed electrode COM of the sub-pixel adjacent to the side subsequently scanned in the screen scanning direction DIR, and the pixel electrode P, respectively.

The gate electrode G, the drain electrode D, and the source electrode S of the main thin film transistor Qa are connected to the main-scanning wiring MSCN, the video wiring SIG, and the pixel electrode P, respectively.

The pixel electrode P with the strip-like or comb-like planar shape is formed as the arrangement with the IPS structure where the pixel capacity Cpx is formed between the pixel electrode P and the opposed electrode COM via the liquid crystal layer LC by generating the electric field in parallel with the surface of the first substrate SUB1. The retention capacity Cst is formed between the pixel electrode P and the opposed electrode COM via the insulation film (PAS1 shown in FIG. 8C).

The second substrate SUB2 and the first substrate SUB1 are arranged to face with each other via the liquid crystal layer LC, and the gap therebetween is filled with the liquid crystal composition. The phase difference plate and the polarization plate (not shown) are provided outside the first substrate SUB1 and the second substrate SUB2 to form the liquid crystal display device in the NB display mode.

The main-scanning wiring MSCN is connected to the main-scanning wiring drive circuit 10. The sub-scanning wiring SSCN is connected to the sub-scanning drive circuit 11. The video wiring SIG is connected to the video wiring drive circuit 13. The opposed electrode COM is connected to the opposed voltage generation circuit 14.

The parasitic capacity Cgsa is formed between the gate electrode G and the source electrode S of the main thin film transistor Qa. The parasitic capacity Cgsb is formed between the gate electrode g and the source electrode s of the sub thin film transistor Qb.

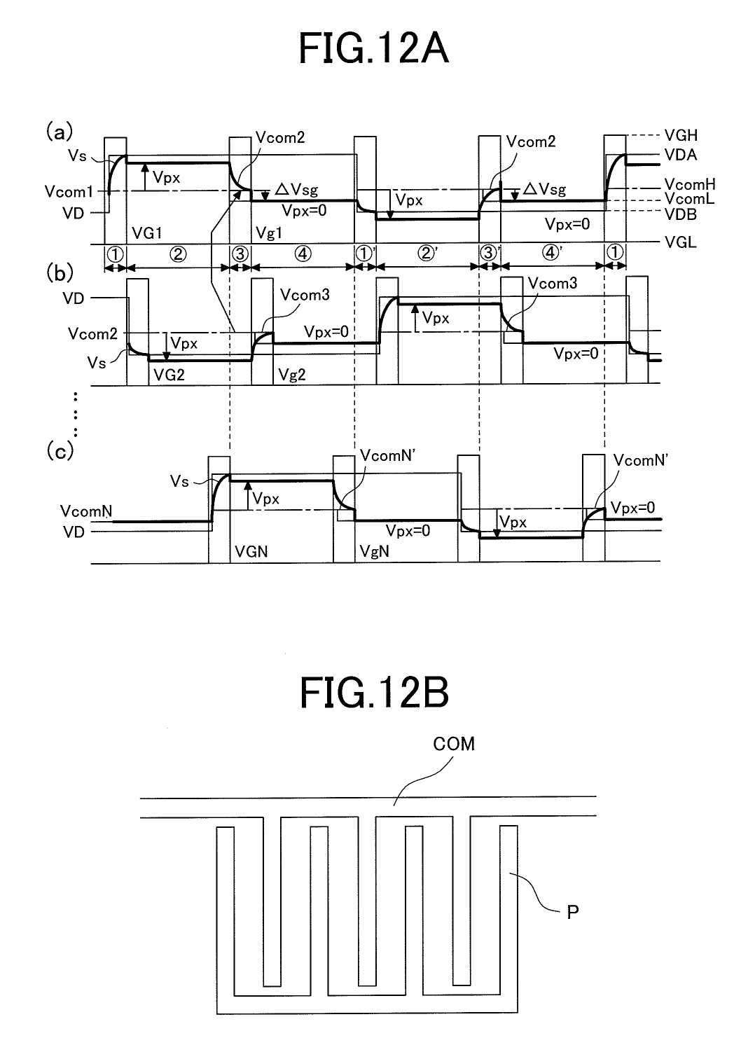

FIG. 12A shows each drive voltage waveform of the respective portions of the liquid crystal display device of the embodiment. FIG. 12A(a) shows the drive voltage waveform on the first display line upon start of the screen scanning. FIG. 12A(b) shows the drive voltage waveform on the second display line. FIG. 12A(c) shows the drive voltage waveform on the Nth display line at the end of the screen scanning.

Likewise the first and the second embodiments, the second frame time is formed of the time sections [3] ([3]′) and [4] ([4]′) for which the sub-scanning wiring SSCN is brought into the selective state and the non-selective state, respectively while keeping the main-scanning wiring MSCN in the non-selective state.

The Vcom1 denotes the voltage waveform of the opposed electrode COM on the first display line, Vcom2 denotes the voltage waveform of the opposed electrode COM on the second display line, and the VcomN denotes the voltage waveform of the opposed electrode COM on the Nth display line. The opposed electrodes are independently controlled.

Referring to FIG. 1B-1(a), after the first frame time formed of the time sections [1] and [2], the frame time is switched to the second frame time formed of the time sections [3] and [4]. In the second frame time, the main-scanning wiring MSCN on the first display line is brought into the non-selective state while keeping the main-scanning wiring voltage VG1 on the first display line at OFF voltage VGL of the main thin film transistor Qa. In the second frame time on the first display line, the opposed voltage Vcom1 supplied to the opposed electrode on the first display line is decreased to be lower than the voltage of VcomH in the first frame time in synchronization with the start of the time section [3], and the value is kept even after switching the time section to [4].

The level of the opposed voltage Vcom2 supplied to the opposed electrode COM on the second display line adjacent to the side subsequently scanned in the screen scanning direction DIR is changed in synchronization with the start of the time section [3] on the second display line in the frame time switched to the second frame time. In the time section [3] in the second frame time on the first display line, the voltage of VcomH in the first frame time is maintained.

When the sub-scanning wiring voltage Vg1 on the first display line is set to ON voltage VGH of the sub thin film transistor Qb to bring the sub-scanning wiring SSCN on the first display line into the selective state, the pixel electrode voltage Vs of the entire sub-pixels on the first display line is charged to reach the opposed voltage Vcom2 supplied to the opposed electrode on the second display line via the sub thin film transistor Qb, that is, the voltage of VcomH.

In the time section [4] for which the sub-scanning wiring voltage Vg1 on the first display line is set to OFF voltage VGL of the sub thin film transistor Qb to bring the sub-scanning wiring SSCN on the first display line into the non-selective state, the pixel electrode voltage Vs of the entire sub-pixels on the first display line is decreased by the amount corresponding to the feed through voltage ·Vsg resulting from the change in the sub-scanning wiring voltage Vg1 on the first display line from ON voltage VGH to OFF voltage VGL, and the parasitic capacity Cgsb of the sub thin film transistor Qb. The aforementioned state is maintained.

The voltage of the VcomL after lowering the opposed voltage Vcom1 is preliminarily set as shown in the following formula (8) with respect to the voltage of VcomH before lowering the Vcom1 so as to allow the difference between the pixel electrode voltage Vs maintained in the time section [4] and the opposed voltage Vcom1, that is, VcomL to become zero.

$$\begin{matrix}[ Formula 6 ] & \\ VcomL = VcomH - \frac{Cgsb}{Cpx + Cst + Cgsa + Cgsb} ( VGH - VGL ) & ( 8 )\end{matrix}$$

As a result, the black frame may be displayed by setting the liquid crystal application voltage Vpx of the entire sub-pixels on the first display line to zero.

Thereafter, the opposed voltage Vcom1 is returned to the voltage of VcomH in the first frame time again in synchronization with switching from the second frame time to the first frame time. The frame time is further switched to the second frame time to start the time section [3]′ where the same driving operation is performed. The aforementioned operations are the same as those performed on the second and subsequent lines as shown in FIGS. 12-1(b) and 12-1(c).

As the Nth display line where the screen scanning ends, the dummy sub-pixel or the dummy opposed electrode corresponding to the (N+1)th display line is provided as the display line adjacent to the side subsequently performed in the screen scanning direction DIR, to connect the drain electrode d of the sub thin film transistor Qb of the sub-pixel on the Nth display line.

The dummy opposed electrode is assumed to be the (N+1)th display line so as to be driven with the waveform as the VcomN′ shown in FIG. 12A(c).

The embodiment allows the image and the black frame to be displayed alternately for improving the video quality by inserting the black frame between the images.

Likewise the second embodiment, in the embodiment, the sub-scanning wiring SSCN may be driven in the middle of the single frame time for starting the screen scanning. The resultant effects are the same as those derived from the second embodiment.

The opposed voltage Vcom supplied to the opposed electrode COM on the subject display line is accorded with the opposed voltage Vcom supplied to the opposed electrode COM on the display line subsequently scanned in the screen scanning direction DIR to perform the driving operation with the same drive voltage waveform as that of the fifth embodiment. The resultant effects are the same as those derived from the fifth embodiment.

In the seventh to the tenth embodiments, the pixel structure in the IPS display mode has the pixel electrode P with the strip-like or comb-like planar shape. The pixel capacity Cpx is formed between the pixel electrode P and the opposed electrode COM by generating the electric field in parallel with the surface of the first substrate SUB1 to form the electrode arrangement with the IPS structure. Each planar shape of the pixel electrode P and the opposed electrode COM is not limited to the one described in the embodiment. The structure having the pixel electrode P and the opposed electrode COM disposed on the same plane may be employed as shown in FIG. 12B.

The liquid crystal display device of active matrix type in the NB display mode having the opposed electrode COM serving as the retention capacity wiring may be effective for substantially all the display modes.

In the seventh to the tenth embodiments, the retention capacity Cst is formed between the pixel electrode P and the opposed electrode COM via the insulation film. However, it may be formed between the source electrode of the sub thin film transistor Qb and the opposed electrode COM via the insulation film, or formed between the source electrode S of the main thin film transistor Qa and the opposed electrode COM via the insulation film. It may be formed by combining the aforementioned processes.

### Eleventh Embodiment

The eleventh embodiment provides the liquid crystal display device including the transmission portion in the NB display mode and the reflection portion in NW display mode in the single sub-pixel with the IPS display mode.

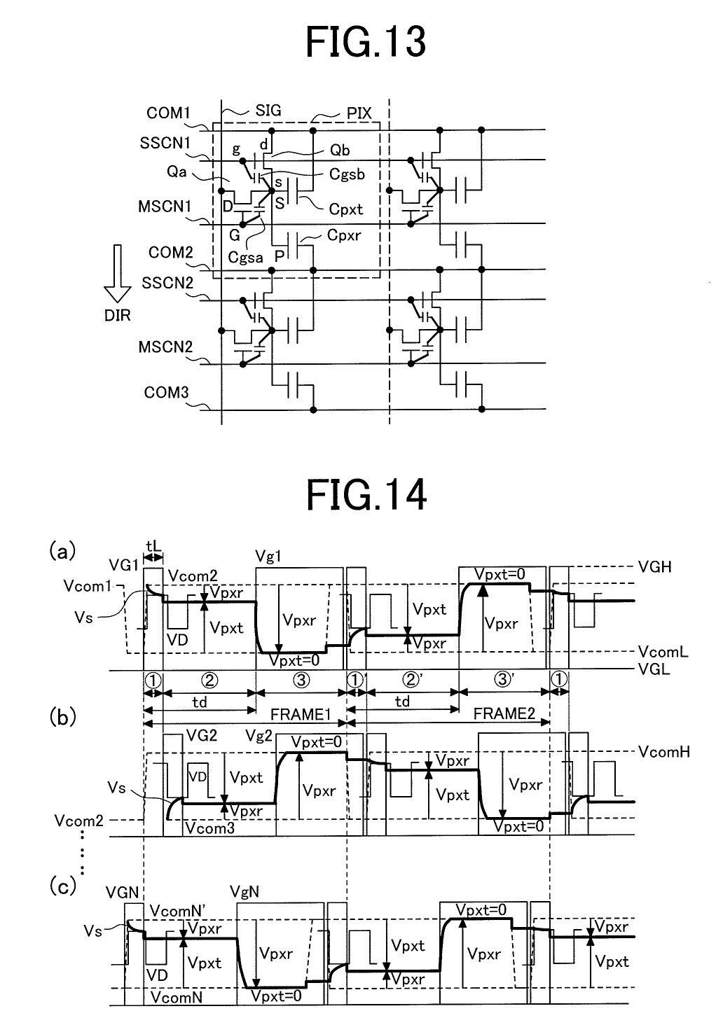

FIG. 13 shows the equivalent circuit of the pixel structure of the liquid crystal display device according to the eleventh embodiment of the invention. The embodiment provides the liquid crystal display device of active matrix type using the thin film transistor.

In the embodiment, the main-scanning wirings MSCN1, MSCN2 and the like, and the opposed electrodes COM1, COM2 and the like for the transmission portion, the opposed electrodes COM2, COM3, and the like for the reflection portion each serving as the retention capacity wiring, and the sub-scanning wirings SSCN1, SSCN2 and the like corresponding to the respective main-scanning wirings MSCN1, MSCN2 and the like are formed on the first substrate SUB1. The video wiring SIG is further formed to intersect with those wirings. As the broken line shows, the main thin film transistor Qa and the sub thin film transistor Qb are disposed in each of the sub-pixels PIX defined by the main-scanning wiring MSCN and the video wiring SIG.

The gate electrode g, the drain electrode d, and the source electrode s of the sub thin film transistor Qb are connected to the sub-scanning wiring SSCN, the opposed electrode COM1 for the transmission portion, and the pixel electrode P, respectively.

The gate electrode G, the drain electrode D and the source electrode S of the main thin film transistor Qa are connected to the main-scanning wiring MSCN, the video wiring SIG, and the pixel electrode P, respectively.

The pixel electrode P has the strip-like or the comb-like planar shape. A pixel capacity Cpxt for the transmission portion is formed between the pixel electrode P and the opposed electrode COM1 for the transmission portion via the transmission portion liquid crystal layer LCT by generating the electric field in parallel with the surface of the first substrate SUB1, and the pixel capacity Cpxr for the reflection portion is formed between the pixel electrode P and the opposed electrode COM2 for the reflection portion via the liquid crystal layer LCR for the reflection portion by generating the electric field in parallel with the surface of the first substrate SUB1 to form the electrode arrangement with the IPS structure.

The retention capacities Cstt and Cstr are formed between the pixel electrode P and the opposed electrode for the transmission portion COM1, and between the pixel electrode P and the opposed electrode COM2 for the reflection portion via the insulation films, respectively. The retention capacities Cstt and Cstr are connected in parallel with the pixel capacity Cpxt for the transmission portion and the pixel capacity Cpxr for the reflection portion, which are not shown in the drawings.

The opposed electrode COM2 for the reflection portion may be commonly used as the one for the transmission portion of the sub-pixel adjacent to the side subsequently scanned in the screen scanning direction DIR.

The second substrate SUB2 and the first substrate SUB1 are disposed to face with each other via the liquid crystal layers LCT and LCR to fill the gap therebetween with the liquid crystal composition.

The liquid crystal device is structured to have the transmission portion in the NB display mode, and the reflection portion in the NW display mode by disposing the phase difference plate and the polarization plate (not shown) outside the first substrate SUB1 and the second substrate SUB2.

The main-scanning wirings MSCN1, MSCN2 and the like are connected to the main-scanning wiring drive circuit 10. The sub-scanning wirings SSCN1, SSCN2 and the like are connected to the sub-scanning wiring drive circuit 11. The video wiring SIG is connected to the video wiring drive circuit 13. The opposed electrodes COM1, COM2 and the like are connected to the opposed voltage generation circuit 14.

The parasitic capacity Cgsa is formed between the gate electrode G and the source electrode S of the main thin film transistor Qa, and the parasitic capacity Cgsb is formed between the gate electrode g and the source electrode s of the sub thin film transistor Qb.

FIG. 14 shows each drive voltage waveform of the respective portions of the liquid crystal display device according to the eleventh embodiment. FIG. 14(a) shows the drive voltage waveform on the first display line upon the start of the screen scanning. FIG. 14(b) shows the drive voltage waveform on the second display line. FIG. 14(c) shows the drive voltage waveform on the Nth display line at the end of the screen scanning.

Likewise the third and the seventh embodiments, the second frame time is formed only of the time section [3] ([3]′) for which the sub-scanning wiring SSCN is brought into the selective state while keeping the main-scanning wiring MSCN in the non-selective state.

Referring to FIG. 14(a), VG1 denotes the voltage waveform of the main-scanning wiring MSCN1 on the first display line as the head display line on the screen, Vg1 denotes the voltage waveform of the sub-scanning wiring SSCN1 on the first display line, VD denotes the voltage waveform of the subject video wiring SIG, the Vcom1 denotes the voltage waveform of the opposed electrode COM1 for the transmission portion, Vcom2 denotes the voltage waveform of the opposed electrode COM2 for the reflection portion, Vs denotes the voltage waveform of the pixel electrode P of the subject sub-pixel PIX, Vpxt denotes the liquid crystal application voltage applied to the pixel capacity Cpxt for the transmission portion as the differential voltage between the pixel electrode voltage Vs and the opposed voltage Vcom1 supplied to the opposed electrode for the transmission portion, and Vpxr denotes the liquid crystal application voltage applied to the pixel capacity Cpxr for reflection portion as the differential voltage between the pixel electrode voltage Vs and the opposed voltage Vcom2 supplied to the opposed electrode for the reflection portion. The respective opposed electrodes are independently controlled.

The first frame time on the first display line is started upon the start of screen scanning of the first frame. The first frame time is formed of the time section [1] for which the main-scanning wiring voltage VG1 on the first display line is set to ON voltage VGH of the main thin film transistor Qa to bring the main-scanning wiring MSCN1 on the first display line into the selective state, and the time section [2] for which the main-scanning wiring voltage VG1 on the first display line is set to OFF voltage VGL to bring the main-scanning wiring MSCN1 on the first display line into the non-selective state.

In the first frame time, the sub-scanning wiring SSCN1 on the first display line is brought into the non-selective state while keeping the sub-scanning wiring voltage Vg1 on the first display line at OFF voltage VGL of the sub thin film transistor Qb. Assuming that the time for selecting the main-scanning wiring MSCN1, that is, the length of the time section [1] is set to tL, the opposed voltage Vcom1 supplied to the opposed electrode for the transmission portion on the first display line is changed to the voltage of VcomL at least tL before bringing the main-scanning wiring MSCN1 on the first display line into the selective state.

When the time section [1] is started while bringing the main-scanning wiring MSCN1 on the first display line into the selective state, the opposed voltage Vcom2 supplied to the opposed electrode for the reflection portion on the first display line commonly used as the opposed electrode COM2 for the transmission portion on the second display line is changed to the voltage of VcomH.

In the time section [1], when the main-scanning wiring voltage VG1 on the first display line is set to ON voltage VGH to bring the main-scanning wiring MSCN1 on the first display line into the selective state, the pixel electrode voltage Vs of the sub-pixels on the first display line is charged to the voltage VD of the video wiring SIG via the main thin film transistor Qa on the first display line.

When the time section is switched to [2] without changing the opposed voltage Vcom1 supplied to the opposed electrode for the transmission portion and the opposed voltage Vcom2 supplied to the opposed electrode for the reflection portion, the pixel electrode voltage Vs for the sub-pixels on the first display line is decreased by the amount corresponding to the feed through voltage resulting from the change in the main-scanning wiring voltage VG1 from ON voltage VGH to OFF voltage VGL, and the parasitic capacity Cgsa of the main thin film transistor Qa. The aforementioned state is maintained.

The differential voltage between the pixel electrode voltage Vs and the opposed voltage Vcom1 supplied to the opposed electrode for the transmission portion, that is, Vs−VcomL is supplied to the pixel capacity Cpxt for the transmission portion in the sub-pixels on the first display line as the liquid crystal application voltage Vpxt for the transmission portion corresponding to the image signal. The liquid crystal layer LCT of the pixel capacity Cpxt for the transmission portion is operated to display the transmission image on the transmission portion of the sub-pixels on the first display line.

The differential voltage between the pixel electrode voltage Vs and the opposed voltage Vcom2 supplied to the opposed electrode for the reflection portion, that is, Vs−VcomH is applied to the pixel capacity Cpxr for the reflection portion of the sub-pixels on the first display line as the liquid crystal application voltage Vpxr for the reflection portion corresponding to the image signal. The liquid crystal layer LCR of the pixel capacity Cpxr for the reflection portion is operated to display the reflection image on the reflection portion of the sub-pixels on the first display line.

After the elapse of the delay time td in the first frame, the frame time is switched to the second frame time formed only of the time section [3]. In the second frame time, the main-scanning wiring MSCN1 on the first display line is brought into the non-selective state while keeping the main-scanning wiring voltage VG1 on the first display line at OFF voltage VGL of the main thin film transistor Qa.

In the time section [3], when the sub-scanning wiring SSCN1 on the first display line is brought into the selective state while keeping the sub-scanning wiring voltage Vg1 on the first display line at ON voltage VGH of the sub thin film transistor Qb, the pixel electrode voltage Vs of the entire sub-pixels on the first display line is charged to the opposed voltage Vcom1 (=VcomL) supplied to the opposed electrode for the transmission portion via the sub thin film transistor Qb. The voltage is continuously applied.

In the time section [3], the pixel electrode voltage Vs may be made equal to the opposed voltage Vcom1 supplied to the opposed electrode for the transmission portion so as to set the liquid crystal application voltage Vpxt for the transmission portion in the time section [3] to zero.

As the transmission portion is in the NB display mode, the black frame display may be performed in the transmission portion of the entire sub-pixels on the first display line.

Meanwhile, the liquid crystal application voltage Vpxr for the reflection portion in the time section [3] becomes the value corresponding to the difference between the pixel electrode voltage Vs equal to the opposed voltage Vcom1 supplied to the opposed electrode for the transmission portion and the opposed voltage Vcom2 supplied to the opposed electrode for the reflection portion, that is, the value of Vcom1−Vcom2 =VcomL−VcomH. The difference between the opposed voltage Vcom1 supplied to the opposed electrode for the transmission portion and the opposed voltage Vcom2 supplied to the opposed electrode for the reflection portion is set to the value substantially corresponding to the black frame display voltage in the NW display mode used for the reflection portion such that the black frame display is performed through the reflection display in the entire sub-pixels on the first display line.

In the first frame time, when the screen scanning reaches the Nth display line as the last display line as shown in FIG. 14(c), the first frame time is started upon the start of the screen scanning on the second frame. The first frame time formed of the time sections [1]′ and [2]′ is substantially the same as the previous first frame time except the point as follows.

The opposed voltage Vcom1 supplied to the opposed electrode for the transmission portion on the first display line is changed to the voltage of VcomH at least tL before bringing the main-scanning wiring MSCN1 on the first display line into the selective state. When the time section [1]′ is started by bringing the main-scanning wiring MSCN1 on the first display line into the selective state, the opposed voltage Vcom2 supplied to the opposed electrode for the reflection portion on the first display line is changed to the voltage of VcomL. The polarity of the voltage VD of the video wiring SIG with respect to the opposed voltage Vcom1 supplied to the opposed electrode for the transmission portion is reverse to the one in the previous first frame time.

The differential voltage between the pixel electrode voltage Vs and the opposed voltage Vvom1 supplied to the opposed electrode for the transmission portion, that is, Vs-VcomH is applied to the pixel capacity Cpxt for the transmission portion of the sub-pixels on the first display line as the liquid crystal application voltage Vpxt for the transmission portion corresponding to the image signal. The liquid crystal layer LCT of the pixel capacity Cpxt for the transmission portion is then operated to display the transmission image on the transmission portion of the sub-pixels on the first display line.

The differential voltage between the pixel electrode voltage Vs and the opposed voltage Vcom2 supplied to the opposed electrode for the reflection portion, that is, Vs−VcomL is applied to the pixel capacity Cpxr for the reflection portion of the sub-pixels on the first display line as the liquid crystal application voltage Vpxr for the reflection portion corresponding to the image signal. The liquid crystal layer LCR of the pixel capacity Cpxr for the reflection portion is then operated to display the reflection image on the reflection portion of the respective sub-pixels on the first display line.

Each polarity of the liquid crystal application voltages for both the transmission portion and the reflection portion is reversed to the one in the previous first frame time. As a result, each pixel capacity for the transmission portion and the reflection portion may be AC driven to display the image.

In the second frame, the frame time is switched to the second frame time after the elapse of the delay time td. The second frame time formed only of the time section [3]′ is substantially the same as the previous second frame time formed of the time section [3] except the following point.

In the time section [3]′, when the sub-scanning wiring SSCN1 on the first display line is brought into the selective state while keeping the sub-scanning wiring voltage Vg1 on the first display line at ON voltage VGH of the sub thin film transistor Qb, the pixel electrode voltage Vs of the entire sub-pixels on the first display line is charged to the opposed voltage Vcom1 supplied to the opposed electrode for the transmission portion via the sub thin film transistor Qb, that is, VcomH. The voltage is continuously applied.

In the time section [3]′, the pixel electrode voltage Vs may be made equal to the opposed voltage Vcom1 supplied to the opposed electrode for the transmission portion. This makes it possible to set the liquid crystal application voltage Vpxt for the transmission portion to zero in the time section [3]. Accordingly, as the transmission portion is in the NB display mode, the black frame display may be performed for transmission display in the entire sub-pixels on the first display line.

Meanwhile, the liquid crystal application voltage Vpxr for the reflection portion in the time section [3]′ becomes the difference between the pixel electrode voltage Vs equal to the opposed voltage Vcom1 supplied to the opposed electrode for the transmission portion and the opposed voltage Vcom2 supplied to the opposed electrode for the reflection portion, that is, Vcom1−Vcom2=VcomH−VcomL. The resultant polarity becomes reversed to the one in the previous second frame time. The black frame display may be performed for the reflection display in the entire sub-pixels on the first display line. This makes it possible to AC drive the pixel capacity Cpxr for the reflection portion when driving the reflection portion for the black frame insertion.

When the screen scanning in the first frame time reaches the Nth display line as the last display line, the screen scanning of the third frame is started to switch the frame time to the first frame time again. The repetition of the aforementioned operations makes it possible to display both the image and the black frame display alternately. The above-described operations are the same as those performed on the second and subsequent display lines as shown in FIGS. 14(b) and 14(c).

For the Nth display line corresponding to the display line where the screen scanning ends, the dummy sub-pixel or the dummy opposed electrode corresponding to the (N+1)th display line is provided as the display line adjacent to the side subsequently scanned in the screen scanning direction DIR such that the dummy opposed electrode is considered as the one for the transmission portion of the sub-pixel on the (N+1)th display line, and commonly used as the opposed electrode for the reflection portion of the sub-pixels on the Nth display line. It is then driven with the drive voltage waveform as shown by VcomN′ in FIG. 14(c).

The aforementioned operations allow the image and the black frame to be displayed alternately both on the transmission portion and the reflection portion. The black frame may be inserted between the images to improve the video quality.

Likewise the second embodiment, the sub-scanning wiring SSCN is driven to start the screen scanning in the middle of the single frame time. The resultant effects are the same as those derived from the second embodiment. Likewise the third embodiment, driving is performed to keep the sub-scanning wiring SSCN on the respective display lines in the selective state in the second frame time. The resultant effects are the same as those derived from the third embodiment.

The opposed voltage Vcom1 supplied to the opposed electrode for the transmission portion on the first display line is changed at least tL before bringing the main-scanning wiring MSCN into the selective state in the last section of the second frame time. Then the pixel electrode voltage Vs is changed by the amount corresponding to the feed through voltage resulting from the change in Vcom1 and the pixel capacity Cpxt for the transmission portion. However, as the tL is sufficiently short compared with the length of the second frame time, the influence to the change in the pixel electrode voltage Vs is negligible.

In the embodiment, the opposed voltage supplied to the opposed electrode for the transmission portion and the opposed voltage supplied to the opposed electrode for the reflection portion on the respective display lines are changed in synchronization with the switching from the second frame time to the first frame time on the respective display lines. However, they may be changed accompanied with switching from the first frame time to the second frame time so long as they are kept substantially constant in the respective scanning periods.

In the embodiment as the pixel structure of IPS display mode, the pixel electrode P has the strip-like or the comb-like planar shape. The pixel capacity Cpxt for the transmission portion is formed between the pixel electrode P and the opposed electrode COM1 for the transmission portion by generating the electric field in parallel with the surface of the first substrate SUB1, and the pixel capacity Cpxr for the reflection portion is formed between the pixel electrode P and the opposed electrode COM2 for the reflection portion by generating the electric field in parallel with the surface of the first substrate SUB1 to form the electrode arrangement with the IPS structure. However, the shapes of the pixel electrode and the opposed electrode are not limited to the planar shape as described in the embodiment. The structure on which the pixel electrode P and the opposed electrode COM are disposed on the same plane may be employed.

In the embodiment, the retention capacities Cstt and Cstr are formed between the pixel electrode and the opposed electrode COM1 for the transmission portion, and between the pixel electrode and the opposed electrode for the reflection portion via the insulation film, respectively. However, it may be formed between the source electrode S of the main thin film transistor Qa and the opposed electrode via the insulation film, or between the source electrode s of the sub thin film transistor Qb and the opposed electrode via the insulation film. Alternatively, it may be formed by combining the aforementioned processes.

In the embodiment, the opposed electrode COM2 of the reflection portion is commonly used as the one for the transmission portion in the sub-pixel adjacent to the side subsequently scanned in the screen scanning direction DIR. It may be commonly used as the opposed electrode COM2 for the transmission portion in the sub-pixel adjacent to the side previously scanned in the screen scanning direction DIR. In the aforementioned case, the drain electrode d of the sub thin film transistor Qb is connected to the opposed electrode for the display portion of the NB display mode.

Besides the aforementioned structure, the drain electrode d of the sub thin film transistor Qb is connected to the opposed electrode or the retention capacity wiring at the equal voltage for the display portion of the NB display mode in the case where the transmission portion is in the NW display mode and the reflection portion is in the NB display mode. Besides the IPS display mode, the liquid crystal display device of active matrix type with the display portion of the NB display mode and the display portion of the NW display mode in the single sub-pixel may be effective for substantially all the display modes.

In all the embodiments as described above, ON voltage of the sub thin film transistor Qb may be set such that the sub thin film transistor Qb is set to ON to sufficiently charge the pixel electrode to the retention capacity voltage or the opposed voltage supplied to the opposed electrode by the sub thin film transistor Qb. It does not have to be made equal to the ON voltage of the main thin film transistor Qa.

The OFF voltage of the sub thin film transistor Qb may be set such that the sub thin film transistor Qb is set to OFF to substantially cut the electric coupling between the pixel electrode and the retention capacity voltage or the opposed voltage supplied to the opposed electrode by the sub thin film transistor Qb. It does not have to be made equal to the OFF voltage of the main thin film transistor Qa.

Upon driving in the second frame time formed of the time sections [4] and [4]′, the time sections [3] and [3]′ may be arbitrarily set so long as the pixel electrode is sufficiently charged to the retention capacity voltage or the opposed voltage supplied to the opposed electrode by the sub thin film transistor Qb. It does not have to be made equal to each length tL of the time sections [1] and [1]′ in the first frame time.

The phase difference plate may be added when necessary for realizing the desired display mode. Conversely, it may be eliminated when it is unnecessary. For example, in the guest-host display mode, the polarization plate may be eliminated if it is unnecessary.

In all the embodiments as described above, the blink-backlight, the overdrive operation, FBI driving as the known technique for improving the video quality may be employed for further improving the video quality.

The metal electrode may be used to be electrically coupled with the opposed electrode at least partially on the upper layer or the lower layer of the opposed electrode. This makes it possible to reduce the resistance of the opposed electrode. Especially, it is effective for the opposed electrode formed of the transparent conductive material with high resistance ratio such as ITO. The insulation film for forming the retention capacity may be formed by layering plural different kinds of materials.

The liquid crystal display device is provided with the backlight on the side opposite the display surface. The liquid crystal layer may be aligned through the horizontal alignment, twisted alignment, vertical alignment, hybrid alignment and the like.

As has been described with respect to the invention, it is to be understood that the invention is not limited to the embodiments as described above, and may be changed into various forms without departing from the scope of the invention.

What is claimed is:

1. A liquid crystal display device comprising:
a liquid crystal display panel provided with a plurality of sub-pixels, a plurality of video wirings for inputting a video voltage to the sub-pixels, a plurality of main-scanning wirings for inputting a selective scanning voltage to the sub-pixels, a plurality of sub-scanning wirings provided corresponding to the plurality of the main-scanning wirings, and a retention capacity wiring;
a video wiring drive circuit for supplying the video voltage to the plurality of the video wirings;
a main-scanning wiring drive circuit for supplying a main-scanning voltage to the plurality of the main-scanning wirings;
a sub-scanning wiring drive circuit for supplying a sub-scanning voltage to the plurality of the sub-scanning wirings; and
a retention capacity voltage generation circuit for supplying a retention capacity voltage to the retention capacity wiring,
wherein each of the sub-pixels includes a pixel electrode, an opposed electrode, a main transistor and a sub transistor;
an opposed voltage generation circuit is provided for supplying an opposed voltage to the opposed electrode;
the main transistor has a gate electrode connected to the main-scanning wiring, a first electrode connected to the video wiring, and a second electrode connected to the pixel electrode; and
the sub transistor has a gate electrode connected to the sub-scanning wiring, a first electrode connected to the retention capacity wiring, and a second electrode connected to the pixel electrode.

2. The liquid crystal display device according to claim 1, wherein a retention capacity is provided at one of portions between the second electrode of the main transistor and the retention capacity wiring, between the second electrode of the sub transistor and the retention capacity wiring, and between the pixel electrode and the retention capacity wiring.

3. The liquid crystal display device according to claim 1, wherein the retention capacity wiring is provided common to all the sub-pixels.

4. The liquid crystal display device according to claim 1, wherein the retention capacity wiring is divided for every display line.

5. The liquid crystal display device according to claim 4, wherein the first electrode of the sub transistor is connected to the retention capacity wiring on the display line scanned immediately previously.

6. The liquid crystal display device according to claim 4, wherein the first electrode of the sub transistor is connected to the retention capacity wiring on the display line subsequently scanned.

7. The liquid crystal display device according to claim 1,
wherein the main-scanning wiring drive circuit supplies the main-scanning voltage which turns the main transistor on in a first period, and turns the main transistor off from a second to a fourth period following the first period to the plurality of the main-scanning wirings sequentially; and
the sub-scanning wiring drive circuit supplies the sub scanning voltage which turns the sub transistor off in the first period and the following second period, turns the sub transistor on in the third period following the second period, and turns the sub transistor off in the fourth period following the third period to the plurality of the sub-scanning wirings sequentially.

8. The liquid crystal display device according to claim 1,
wherein the main-scanning wiring drive circuit supplies the main-scanning voltage which turns the main transistor on in a first period, and turns the main transistor off from a second to a third period following the first period to the plurality of the main-scanning wirings sequentially; and
the sub-scanning wiring drive circuit supplies the sub-scanning voltage which turns the sub transistor off in the first period and the following second period, and turns the sub transistor on in the third period following the second period to the plurality of the sub-scanning wirings sequentially.

9. The liquid crystal display device according to claim 7, wherein the retention capacity voltage generation circuit supplies the retention capacity voltage which is kept constant to the retention capacity wiring.

10. The liquid crystal display device according to claim 7,
wherein when the video voltage supplied to the video wirings from the video wiring drive circuit at a higher potential than an opposed voltage input to the opposed electrode is set as a positive video voltage, and the video voltage supplied to the video wirings from the video wiring drive circuit at a lower potential than the opposed voltage input to the opposed electrode is set as a negative video voltage, the retention capacity voltage generation circuit supplies the retention capacity voltage of VstL to the retention capacity wiring when supplying the positive video voltage to the video wirings from the video wiring drive circuit in the first period, and supplies the retention capacity voltage of VstH at the higher potential than the VstL to the retention capacity wiring when supplying the negative video voltage to the video wirings from the video wiring drive circuit; and
the opposed voltage generation circuit supplies the opposed voltage of VcomL to the opposed electrode when supplying the positive video voltage to the video wirings from the video wiring drive circuit in the first period, and supplies the opposed voltage of VcomH at the higher potential than the VcomL to the opposed electrode in the first period when supplying the negative video voltage from the video wiring drive circuit to the video wirings.

11. The liquid crystal display device according to claim 9, wherein a voltage supplied from the opposed voltage generation circuit to the opposed electrode is equal to the retention capacity voltage supplied to the retention capacity wiring.

12. The liquid crystal display device according to claim 9, wherein a voltage supplied from the opposed voltage generation circuit to the opposed electrode is decreased from the retention capacity voltage supplied to the retention capacity wiring by an amount corresponding to a predetermined voltage.

13. The liquid crystal display device according to claim 4,
wherein the main-scanning wiring drive circuit supplies the main-scanning voltage which turns the main transistor on in a first period and turns the main transistor off from a second to a fourth period following the first period to the plurality of the main-scanning wirings sequentially;
the sub-scanning wiring drive circuit supplies the sub-scanning voltage which turns the sub transistor off in the first period and the following second period, turns the sub transistor on in the third period following the second period, and turns the sub transistor off in the fourth period following the third period to the plurality of the sub-scanning wirings sequentially; and
when the video voltage supplied to the video wirings from the video wiring drive circuit at a higher potential than an opposed voltage input to the opposed electrode is set as a positive video voltage, and the video voltage supplied to the video wirings from the video wiring drive circuit at a lower potential than the opposed voltage input to the opposed electrode is set as a negative video voltage, the retention capacity voltage generation circuit supplies the retention capacity voltage of VstH to the retention capacity wiring in the third and the fourth periods when supplying the positive video voltage to the video wirings from the video wiring drive circuit in the first period, and supplies the retention capacity voltage of VstL at the lower potential than the VstH to the retention capacity wiring in the third and the fourth periods when supplying the negative video voltage to the video wirings from the video wiring drive circuit in the first period.

14. The liquid crystal display device according to claim 4,
wherein the main-scanning wiring drive circuit supplies the main-scanning voltage which turns the main transistor on in a first period, and turns the main transistor off from a second to a third period following the first period to the plurality of the main-scanning wiring sequentially;
the sub-scanning wiring drive circuit supplies the sub-scanning voltage which turns the sub transistor off in the first period and the following second period, and turns the sub transistor on in the third period following the second period to the plurality of the sub-scanning wirings sequentially; and
when the video voltage supplied to the video wirings from the video wiring drive circuit at a higher potential than an opposed voltage input to the opposed electrode is set as a positive video voltage, and the video voltage supplied to the video wirings from the video wiring drive circuit at a lower potential than the opposed voltage input to the opposed electrode is set as a negative video voltage, the retention capacity voltage generation circuit supplies the retention capacity voltage of VstH to the retention capacity wiring in the third period when supplying the positive video voltage to the video wirings from the video wiring drive circuit in the first period, and supplies the retention capacity voltage of VstL at the lower potential than the VstH to the retention capacity wiring in the third period when supplying the negative video voltage to the video wirings from the video wiring drive circuit in the first period.

15. The liquid crystal display device according to claim 13,
wherein the opposed electrode is divided for every display line; and
when the retention capacity voltage supplied to the retention capacity wiring on the display line corresponds to the VstL, the opposed voltage supplied to the opposed electrode on the display line from the opposed voltage generation circuit corresponds to VcomH, and when the retention capacity voltage supplied to the retention capacity wiring on the display line corresponds to the VstH, the opposed voltage corresponds to the VcomL at the lower potential than the VcomH.

16. A liquid crystal display device comprising:
a liquid crystal display panel provided with a plurality of sub-pixels, a plurality of video wirings for inputting a video voltage to the sub-pixels, a plurality of main-scanning wirings for inputting a selective scanning voltage to the sub-pixels, and a plurality of sub-scanning wirings provided corresponding to the plurality of the main-scanning wirings;
a video wiring drive circuit for supplying the video voltage to the plurality of the video wirings;
a main-scanning wiring drive circuit for supplying a main-scanning voltage to the plurality of the main-scanning wirings; and
a sub-scanning wiring drive circuit for supplying a sub-scanning voltage to the plurality of the sub-scanning wirings,
wherein each of the sub-pixels includes a pixel electrode, an opposed electrode, a main transistor and a sub transistor;
an opposed voltage generation circuit is provided for supplying an opposed voltage to the opposed electrode;
the main transistor has a gate electrode connected to the main-scanning wiring, a first electrode connected to the video wiring, and a second electrode connected to the pixel electrode; and
the sub transistor has a gate electrode connected to the sub-scanning wiring, a first electrode connected to the opposed electrode, and a second electrode connected to the pixel electrode.

17. The liquid crystal display device according to claim 16, wherein a retention capacity is provided at one of portions between the second electrode of the main transistor and the opposed electrode, between the second electrode of the sub transistor and the opposed electrode, and between the pixel electrode and the opposed electrode.

18. The liquid crystal display device according to claim 16, wherein the opposed electrode is provided common to all the sub-pixels.

19. The liquid crystal display device according to claim 16, wherein the opposed electrode is divided by for every display line.

20. The liquid crystal display device according to claim 19, wherein the first electrode of the sub transistor is connected to the opposed electrode on the display line scanned immediately previously.

21. The liquid crystal display device according to claim 19, wherein the first electrode of the sub transistor is connected to the opposed electrode on the display line subsequently scanned.

22. The liquid crystal display device according to claim 19,
wherein the main-scanning wiring drive circuit supplies the main-scanning voltage which turns the main transistor on in a first period, and turns the main transistor off from a second to a fourth period following the first period to the plurality of the main-scanning wirings sequentially;
the sub-scanning wiring drive circuit supplies the sub-scanning voltage which turns the sub transistor off in the first period and the following second period, turns the sub transistor on in the third period following the second period, and turns the sub transistor off in the fourth period following the third period to the plurality of the sub-scanning wirings sequentially; and
the opposed voltage generation circuit supplies a voltage of Vcom in the first and the second periods, a voltage of VcomH at a higher potential than the Vcom in the third period, and a voltage of VcomL at a lower potential than the Vcom in the fourth period to the opposed electrodes.

23. The liquid crystal display device according to claim 19,
wherein the main-scanning wiring drive circuit supplies the main-scanning voltage which turns the main transistor on in a first period, and turns the main transistor off from a second to a fourth period following the first period to the plurality of the main-scanning wirings sequentially;
the sub-scanning wiring drive circuit supplies the sub-scanning voltage which turns the sub transistor off in the first period and the following second period, turns the sub transistor on in the third period following the second period, and turns the sub transistor off in the fourth period following the third period to the plurality of the sub-scanning wirings sequentially; and
the opposed voltage generation circuit supplies a voltage of Vcom from the first to the third period, and a voltage of VcomL at a lower potential than the Vcom in the fourth period to the opposed electrodes.

24. The liquid crystal display device according to claim 16,
wherein the main-scanning wiring drive circuit supplies the main-scanning voltage which turns the main transistor on in a first period, and turns the main transistor off from a second to a fourth period following the first period to the plurality of the main-scanning wirings sequentially;
the sub-scanning wiring drive circuit supplies the sub-scanning voltage which turns the sub transistor off in the first period and the following second period, turns the sub transistor on in the third period following the second period, and turns the sub transistor off in the fourth period following the third period to the plurality of the sub-scanning wirings sequentially;
the opposed voltage generation circuit supplies a constant voltage of Vcom to the opposed electrode from the first to the fourth period; and
a predetermined voltage is superimposed with the video voltage input to the pixel electrode in the first period via the main transistor.

25. The liquid crystal display device according to claim 16,
wherein the main-scanning wiring drive circuit supplies the main-scanning voltage which turns the main transistor on in a first period, and turns the main transistor off from a second to a fourth period following the first period to the plurality of the main-scanning wirings sequentially;
the sub-scanning wiring drive circuit supplies the sub-scanning voltage which turns the sub transistor off in the first period and the following second period, turns the sub transistor on in the third period following the second period, and turns the sub transistor off in the fourth period following the third period to the plurality of the sub-scanning wirings sequentially; and
the opposed voltage generation circuit supplies a voltage of VcomH in the first and the second periods and a voltage of VcomL at a lower potential than the VcomH in the third and the fourth periods to the opposed electrodes, respectively.

26. The liquid crystal display device according to claim 16,
wherein the main-scanning wiring drive circuit supplies the main-scanning voltage which turns the main transistor on in a first period, and turns the main transistor off from a second to a third period following the first period to the plurality of the main-scanning wirings sequentially; and
the sub-scanning wiring drive circuit supplies the sub-scanning voltage which turns the sub transistor off in the first period and the following second period, and turns the sub transistor on in the third period following the second period to the plurality of the sub-scanning wirings sequentially.

27. The liquid crystal display device according to claim 16,
wherein the main-scanning wiring drive circuit supplies the main-scanning voltage which turns the main transistor on in a first period, and turns the main transistor off from a second to a third period following the first period to the plurality of the main-scanning wirings sequentially;
the sub-scanning wiring drive circuit supplies the sub-scanning voltage which turns the sub transistor off in the first period and the following second period, and turns the sub transistor on in the third period following the second period to the plurality of the sub-scanning wirings sequentially; and
the opposed voltage generation circuit supplies a constant voltage of Vcom from the first to the third period to the opposed electrodes.

28. A liquid crystal display device comprising:
a liquid crystal display panel provided with a plurality of sub-pixels, a plurality of video wirings for inputting a video voltage to the sub-pixels, a plurality of main-scanning wirings for inputting a selective scanning voltage to the sub-pixels, and a plurality of sub-scanning wirings provided corresponding to the plurality of the main-scanning wirings;
a video wiring drive circuit for supplying the video voltage to the plurality of the video wirings;
a main-scanning wiring drive circuit for supplying a main-scanning voltage to the plurality of the main-scanning wirings; and
a sub-scanning wiring drive circuit for supplying a sub-scanning voltage to the plurality of the sub-scanning wirings,
wherein each of the sub-pixels includes a pixel electrode, an opposed electrode for a transmission portion, an opposed electrode for a reflection portion, a main transistor and a sub transistor;
an opposed voltage generation circuit is provided for supplying an opposed voltage to the opposed electrodes for the transmission portion and the reflection portion;
the main transistor has a gate electrode connected to the main-scanning wiring, a first electrode connected to the video wiring, and a second electrode connected to the pixel electrode; and
the sub transistor has a gate electrode connected to the sub-scanning wiring, a first electrode connected to the opposed electrode for the transmission portion, and a second electrode connected to the pixel electrode.

29. The liquid crystal display device according to claim 28, wherein the opposed electrode for the reflection portion is the opposed electrode for the transmission portion on a display line scanned immediately previously.

30. The liquid crystal display device according to claim 28, wherein the opposed electrode for the reflection portion is the opposed electrode for the transmission portion on a display line subsequently scanned.

31. The liquid crystal display device according to claim 28,
wherein the main-scanning wiring drive circuit supplies the main-scanning voltage which turns the main transistor on in a first period, and turns the main transistor off from a second to a third period following the first period to the plurality of the main-scanning wirings sequentially;
the sub-scanning wiring drive circuit supplies the sub-scanning voltage which turns the sub transistor off in the first period and the following second period, and turns the sub transistor on in the third period following the second period to the plurality of the sub-scanning wirings sequentially; and
when the video voltage supplied to the video wirings from the video wiring drive circuit at a higher potential than an opposed voltage input to the opposed electrode for the transmission portion is set as a positive video voltage, and the video voltage supplied to the video wirings from the video wiring drive circuit at a lower potential than the opposed voltage input to the opposed electrode for the transmission portion is set as a negative video voltage, the opposed voltage generation circuit supplies the opposed voltage of VcomL to the opposed electrode for the transmission portion when supplying the positive video voltage to the video wirings from the video wiring drive circuit in the first period, and supplies the opposed voltage of VcomH at the potential higher than the VcomL to the opposed electrode for the transmission portion when supplying the negative video voltage to the video wirings from the video wiring drive circuit in the first period.

32. The liquid crystal display device according to claim 7,
wherein a single frame time is formed of the first and the second periods, and another single frame time is formed of the third and the fourth periods; and
the first period is shorter than the second period, and the third period is shorter than the fourth period.

33. The liquid crystal display device according to claim 7,
wherein a single frame time is formed of the first to the fourth periods; and
the first period is shorter than the second period and the third period is shorter than the fourth period.

34. The liquid crystal display device according to claim 8,
wherein a single frame time is formed of the first to the third periods; and
the first period is shorter than one of the second period or the third period.
